(19) United States
(12) Patent Application Publication
(10) Pub. No.: US 2025/0371141 A1
(43) Pub. Date: Dec. 4, 2025

(54) APPARATUSES FOR AUDIT DATA GENERATION AND VERIFICATION

(71) Applicants: Robert VAUGHN, Portland, OR (US); Kumar MUTHUSAMI, Sunnyvale, CA (US); Pradeep BALUVANERALU, Bangalore (IN); Owen Y. LOH, Portland, OR (US); Sridhar RAJAPPA, Gilbert, AZ (US)

(72) Inventors: Robert VAUGHN, Portland, OR (US); Kumar MUTHUSAMI, Sunnyvale, CA (US); Pradeep BALUVANERALU, Bangalore (IN); Owen Y. LOH, Portland, OR (US); Sridhar RAJAPPA, Gilbert, AZ (US)

(21) Appl. No.: 19/305,921

(22) Filed: Aug. 21, 2025

(51) Int. Cl. G06F 21/55; G06F 21/44; G06F 21/53; G06F 21/57

(52) U.S. Cl. CPC G06F 21/552; G06F 21/44; G06F 21/53; G06F 21/57

(57) ABSTRACT

It is provided an apparatus comprising interface circuitry, machine-readable instructions, and processing circuitry to execute the machine-readable instructions. The machine-readable instructions include instructions to receive data from a remote entity for handling by a computing system. The machine-readable instructions further include instructions to instantiate a first TEE and a second TEE. The machine-readable instructions further include instructions to generate log data corresponding to predefined activities of the computing system and to generate system record data of a system log of the computing system at predetermined times. The machine-readable instructions further include instructions to generate first audit data by the first TEE and second audit data by the second TEE. The machine-readable instructions further include instructions to transmit the first and the second audit data to a detection system for data aggregation and anomaly detection.

### BACKGROUND

Modern computing environments may involve collaboration between multiple entities over shared computing infrastructure, such as servers deployed in datacenter or cloud settings. These environments may include sensitive workloads and audit-critical data flows originating from different organizations with distinct security and compliance requirements. In such multi-party scenarios, it may be necessary to establish independent zones of trust to ensure that data access, execution behavior, and system activity remain verifiable and isolated. Therefore, improved techniques for generating, securing, and verifying system-level observations across organizational boundaries may be required.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus 100;

FIG. 2 illustrates a block diagram of an example of an apparatus 200;

FIG. 3 illustrates a block diagram of an example of an apparatus 300;

FIG. 4 illustrates a system comprising apparatus 100, apparatus 200 and apparatus 300;

FIG. 5 illustrates a flowchart of an example of a method 500;

FIG. 6 illustrates a flowchart of an example of a method 600;

FIG. 7 illustrates a flowchart of an example of a method 700;

FIG. 8 illustrates an example of a flowchart 800;

FIG. 9 illustrates an example system architecture 900 using dual trusted execution environments (TEEs); and

FIG. 10 illustrates an example of a block diagram of an electronic apparatus 1000.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

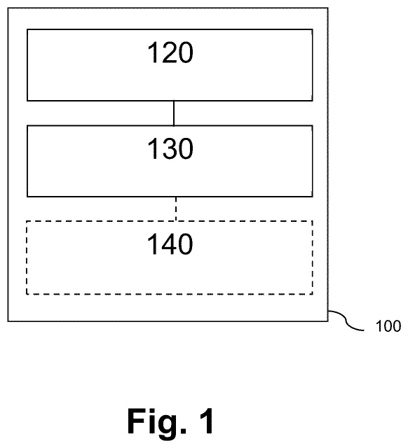

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to receive data from a remote entity for handling by a computing system. For example, the computing system may be a physical or virtual machine, a networked system of interconnected components, or a logically grouped set of processing and storage resources that may be configured to perform data processing, computation, or data handling tasks. The computing system may be embodied by the apparatus 100 or may comprise the apparatus 100 as a subcomponent. In some examples, the computing system may be implemented as a standalone server, a rack-mounted datacenter server, a blade server, or a virtualized machine operating on shared physical infrastructure. The computing system may include multiple execution contexts such as user processes, kernel-space modules, or trusted execution environments.

In some examples, the computing system may be operated by a host entity, which may be an operator, administrator, or infrastructure provider responsible for maintaining and configuring the physical or virtual system. The host entity may control the base operating system of the computing system and may have root-level access or administrative privileges outside of any trusted execution environments. The host entity may instantiate secure monitoring processes, configure access control rules, and enforce policy mechanisms at the system level. In certain deployment contexts, the host entity may be a commercial compute provider, a datacenter operator, or an internal IT department.

The computing system may interact with the remote entity, which may be a distinct stakeholder, customer, or external participant that delegates sensitive computation or data processing tasks to the host entity. The remote entity may transmit the data into the computing system for secure processing, auditing, or isolation. In some examples, the remote entity may also instantiate its own TEE within the computing system to enforce data-handling requirements or observe execution behavior. The remote entity may operate independently of the host entity and may impose attestation or monitoring requirements over the computing system.

For example, receiving data from the remote entity for handling by the computing system may refer to an operation in which the interface circuitry 120 of the apparatus 100 obtains, ingests, or is otherwise provided with information originating from a remote entity, the information being intended for further processing, storage, inspection, or controlled usage within the computing system. The data may be transmitted over a secure or insecure network connection, and may be encoded, encrypted, or authenticated according to policies defined by the remote entity. The receiving may occur through a communication channel coupled to the interface circuitry 120, which may comprise physical or virtual ports, secure gateways, network interface cards, or cryptographic modules.

In some examples, the data from the remote entity may comprise one or more of digital design files, proprietary algorithms, neural network model parameters, biometric records, intellectual property documentation, executable scripts, or runtime configuration data. The data may be intended to be handled, for example, by being stored, accessed, executed, modified, or analyzed by the computing system under observability or access restrictions. Handling data may comprise any form of active or passive interaction by the computing system, including in-memory inspection, metadata extraction, validation, or computation within an isolated execution domain.

For example, in a chip foundry scenario, the computing system may be a secure server operated by a foundry provider such as Intel, while the remote entity may be a customer company such as Acme that provides chip design data to be processed on the server. The computing system may store and manipulate the design data in a controlled execution environment, while audit data is simultaneously generated and observed by trusted execution environments associated with both Intel (host entity) and Acme (remote entity). This arrangement may ensure that the remote entity retains visibility into and confidence over how its data is handled, even in a setting where the underlying infrastructure is operated by the host entity.

The processing circuitry 130 is further configured to instantiate a first trusted execution environment (TEE) operated by a host entity of the computing system and a second TEE operated by the remote entity. For example, a trusted execution environment (TEE) may be an isolated execution context within the computing system that may be instantiated by dedicated hardware or firmware support to execute machine-readable instructions in a protected manner. For example, each of the first and the second TEE may form a logically and physically secured region of the computing system's processor, memory, and instruction flow control, such that code and data processed inside the trusted execution environment may not be accessed, modified, or observed by other components of the computing system, including privileged software such as the host operating system, hypervisors, or administrative agents. Each of the first and the second TEE may thus provide a controlled space for executing sensitive logic, monitoring operations, or handling security-critical data.

In some examples, the first and the second TEE may rely on architecture-specific implementations such as Intel® Software Guard Extensions (SGX), Intel® Trust Domain Extensions (TDX) or the like. These implementations may support cryptographically verifiable code measurement, memory encryption, and access control policies to ensure runtime isolation of the trusted execution environment. The first and the second TEE may also support sealed storage, secure communication, and attestation protocols that allow external systems or remote entities to verify that the trusted execution environment was instantiated with expected code and configuration, and has not been tampered with after instantiation.

For example, instantiating the first and the second TEE may refer to a process by which the processing circuitry 130 initiates isolated execution instances within the computing system, each configured to execute code and process data securely under the respective distinct administrative control. Each TEE may be instantiated with its own identity, cryptographic keys, and measurement-protected memory space, and may operate independently of the host operating system and of each other. In some examples, instantiating the first TEE operated by the host entity may comprise launching a secure enclave, domain, or partition within a secure processor extension, such as Intel® Software Guard Extensions (SGX), where the host entity controls the code and configuration loaded into the TEE. The first trusted execution environment may have direct or indirect access to system resources such as logs, network interfaces, or audit processes, under policies set by the host entity.

In some examples, instantiating the second TEE operated by the remote entity may comprise allocating a separate secure enclave or isolated computation container within the same computing system, with control parameters, execution payloads, and attestation keys provisioned by the remote entity. The remote entity may verify the integrity of the second TEE during or after instantiation. The instantiation process may include loading measurement-verified code into the enclave, sealing or unsealing sensitive configuration data, and binding the TEE to an identity associated with the remote entity.

The remote entity may transmit the data, like proprietary input data, configuration instructions, code artifacts, or intellectual property into the computing system for secure processing, auditing, or isolation. In some examples, the remote entity may also instantiate its own trusted execution environment within the computing system to enforce data-handling requirements or observe execution behavior. The remote entity may operate independently of the host entity and may impose attestation or monitoring requirements over the computing system.

For example, the computing system may be operated by a service provider offering secure processing infrastructure, such as a semiconductor chip foundry or a cloud-based high-performance compute provider. In such scenarios, the remote entity, such as a chip design company may transmit proprietary data to the computing system. This proprietary data may include design specifications for integrated circuits, hardware description language (HDL) files, simulation models, or verification scripts. The service provider, acting as the host entity of the computing system, may offer computational and storage resources to process, simulate, or validate these inputs. Given the sensitivity of the design data, the remote entity may require guarantees that the host entity's personnel, systems, or competing business divisions cannot gain unauthorized insight into the transmitted data. In some examples, the apparatus 100 may be part of a computing system within the foundry's secure processing environment, and may receive the design data from the remote entity via the interface circuitry. Once received, the apparatus 100 may instantiate the first TEE under control of the host entity and the second TEE under control of the remote entity. These TEEs may serve to enforce isolation, monitor access, and record audit data concerning all activities involving the remote entity's design files. For example, if the host entity attempts to read, copy, or transmit the received data without authorization, such actions may be immutably logged and flagged as anomalies (see below). The use of dual trusted TEEs enables mutual verifiability and transparency, even in cases where both parties may not fully trust one another.

In some examples, the first TEE may be configured to operate independently from the second TEE, and each environment is associated with a distinct root of trust. For example, the first TEE and the second TEE may be executing in separate isolated memory regions with no mutual access permissions and by relying on distinct attestation chains. That is, each TEE may be is initialized, managed, and executed without requiring shared credentials, shared management components, or shared cryptographic primitives. For example, this may be achieved by using hardware-assisted isolation features such as Intel® SGX, where each TEE is instantiated with separate cryptographic identities and memory protections. These identities may be tied to different provisioning authorities, e.g., one associated with the foundry operator (host entity) and one associated with the chip design company (remote entity), ensuring mutual independence and trust separation.

For example, the root of trust may be a foundational hardware-based security anchor in the computing system from which the integrity and authenticity of each TEE can be established. Each TEE may rely on a separate root of trust, which may include secure boot firmware, manufacturer-signed keys, and cryptographic modules embedded in the processor. These roots of trust may be used to sign enclave measurements, verify the enclave state at runtime, and bind audit data or execution behavior to a specific enclave identity. For example, the host entity may operate the first TEE rooted in the server manufacturer's provisioning infrastructure, while the remote entity, e.g., the chip design customer, may instantiate the second TEE using its own root of trust provisioned via a secure certificate or key injection process. The use of distinct roots of trust enables each party to verify the integrity of its own enclave without relying on the other, thus supporting tamper-evident separation of control.

In some examples, the second TEE may be configured to receive data input via a secure gateway comprising a hardware security module. The hardware security module may be provisioned with access control policies defined by the remote entity and operating independently of the host operating system of the computing system. For example, the secure gateway may be a hardware- or software-implemented communication channel through which input data is transferred into the second TEE in a controlled and verifiable manner. The secure gateway may serve as a dedicated interface that isolates and filters external data before it is made accessible to the second TEE. The secure gateway may be coupled to the computing system in such a way that the gateway data input cannot be bypassed or rerouted via standard host operating system interfaces, thereby maintaining the integrity of the communication path into the second TEE.

In some examples, the secure gateway may comprise a hardware security module that performs cryptographic validation, data integrity checks, and policy enforcement based on preconfigured security rules. The hardware security module may operate independently of the host operating system of the computing system and may be configured to validate, decrypt, or reject data packets prior to forwarding them to the second TEE. This configuration ensures that only verified and policy-compliant data reaches the second TEE, thereby preventing the host entity or other co-located systems from injecting unauthorized inputs.

In some examples, the hardware security module may be provisioned with access control policies, which may define permitted data sources, authentication requirements, or acceptable data types. The access control policies may be defined or selected by the remote entity to ensure that only properly authorized data, conforming to specified constraints, can be input to the second TEE. The hardware security module may evaluate each incoming request or data item against the provisioned access control policies before releasing it to the secure memory domain of the second TEE. In some examples, the hardware security module may operate independently from the host operating system of the computing system, such that even privileged processes of the host entity cannot override or interfere with policy enforcement.

The processing circuitry 130 is further configured to generate log data corresponding to predefined activities of the computing system associated with the data from the remote entity. For example, the predefined activities of the computing system may comprise a selected set of operations that are relevant to monitoring the handling of the data from the remote entity, and may be specified in advance by configuration or policy. These predefined activities may comprise data access events (such as reads or writes to specific memory regions or files), file input/output operations (such as opening, closing, modifying, or deleting files), network communication events (such as outgoing or incoming data packets), execution traces, process invocations, or privilege elevation attempts. In some examples, the predefined activities may be filtered or narrowed to those that affect or originate from data supplied by the remote entity, such as computations performed over sensitive data, model inference on proprietary inputs, or access attempts to customer-specific design files.

For example, the log data may be generated by the processing circuitry 130 through continuous or event-triggered monitoring of the predefined activities, possibly using low-level instrumentation or kernel-level audit mechanisms. The log data may comprise structured records that describe each observed activity, including metadata such as timestamps, process identifiers, user or role context, memory addresses, file paths, data sizes, or network endpoints. The processing circuitry 130 may implement the generation of log data either directly or through coordination with audit agents running inside the first and the second TEE or within the operating system of the computing system.

In some examples, the log data comprises at least one of data access operations, file input/output operations, or network communication events associated with the data from the remote entity. For example, generating the log data may comprise monitoring at least one of data access operations, file input/output operations, or network communication events associated with the data from the remote entity. Monitoring data access operations may comprise observing actions such as reading, writing, or executing specific files, memory regions, or objects associated with the received data. This may comprise identifying which process or thread accessed the data, under what user privileges, and through which operating system mechanism (e.g., system calls, direct memory access). Monitoring file input/output operations may further capture how files linked to the data from the remote entity are opened, modified, or deleted, and track their access timestamps, access modes (e.g., read-only or writable), and the relationship to broader computational workflows. In parallel, monitoring network communication events may include recording outgoing or incoming connections, remote endpoints, port usage, protocol types, and payload metadata when data derived from or related to the remote entity is transmitted or received over a network.

The processing circuitry 130 may implement this monitoring capability using instrumentation tools or dedicated subsystems of the operating system of the computing system. For instance, the apparatus 100 may use kernel-level audit hooks, such as the Linux Audit subsystem, extended Berkeley Packet Filter (eBPF) programs, or file system notification interfaces (e.g., fanotify, inotify), to capture and log relevant events. Network activity can be monitored using packet inspection, connection tracking, or socket-level event logging. These events may be filtered in real time or post-processed to exclude system noise and focus exclusively on activity that involves the data originating from the remote entity. The result is a targeted, policy-driven set of log entries that document how, when, and by whom the remote data was accessed, manipulated, stored, or communicated, thereby enabling precise accountability and auditability for sensitive workloads, such as intellectual property processing in chip foundry scenarios.

In some examples, the processing circuitry 130 may be further configured to perform the correlation on the monitored predefined activities of the computing system associated with the data from the remote entity, by aggregating and interrelating heterogeneous sources of system behavior data into a verifiable, interpretable activity trail. For example, the processing circuitry 130 may collect and match file system access events, network socket interactions, and system calls that are temporally and logically associated with a specific unit of data received from the remote entity. The correlation may include reconstructing causal relationships between actions, such as detecting that a file received via a network transfer was stored to disk, then opened by a specific process, and subsequently transmitted to an external IP address.

For example, the log data may be generated by correlating system call traces, file system events, and network traffic to construct a coherent and verifiable sequence of events reflecting how the data from the remote entity was used or accessed. This may involve associating low-level execution signals such as system calls (e.g., read( ), write( ), open( ), execve( )) with corresponding file system operations (e.g., reads from specific design files or writes to temporary directories) and network transmissions (e.g., HTTP POST requests or encrypted data streams). By aligning the timestamps and process identifiers of these activities, the processing circuitry 130 or an audit agent running within the first or second TEE may build a chronological map of data flow and control flow in the system. Such a map may show, for instance, that a certain input file received from the remote entity was opened by a particular process, processed by an execution routine, and the result transmitted over a network socket, thereby capturing the entire lifecycle of the data as it traverses the system.

This correlation process may require buffering and analyzing multiple audit data streams in near real time. For instance, the audit mechanism may capture syscall events as described above and monitor network interfaces via packet filters or virtual tap interfaces. These discrete streams may be matched based on context: a unique process ID may tie a read( ) system call on a file descriptor to a later send( ) call on a socket, enabling the system to infer that data originating from a file was transmitted externally. In this way, the correlated log data does not simply consist of raw events but forms a structured, contextualized audit trail that provides traceable and tamper-evident documentation of how the data from the remote entity was handled, which processes interacted with it, and whether any unexpected access patterns occurred.

The processing circuitry 130 is further configured to generate system record data of a system log of the computing system at predetermined times. In some examples, the system log of the computing system may refer to an operating system-maintained or hypervisor-maintained record of events, status information, and/or operational metadata generated during the execution of processes and services by the computing system. The system log may be generated and updated by core system components such as the kernel, device drivers, process schedulers, I/O subsystems, or security modules, and may capture a broad spectrum of diagnostic, control, or error-related entries. These entries may include timestamped messages indicating process creation and termination, memory allocation, access control violations, system calls, context switches, service startups and failures, or resource usage anomalies. For example, the syslog facility in a Unix-like system may be used, or more advanced telemetry traces provided by container orchestration or cloud platforms. The system log thereby serves as a chronological footprint of low-level and high-level system behavior.

In some examples, the system record data may comprise point-in-time state information extracted from a system log of the operating system of the computing system. This system record data may be generated by sampling the state of the system log at regular, predetermined intervals. For example, the processing circuitry 130 may extract a subset of log entries that occurred within a specific time window or generate a snapshot hash or summary of the log buffer contents as they exist at the moment of sampling. The record data may include selected messages related to specific monitored processes, services, or users; kernel version identifiers; resource utilization metrics such as CPU load or memory pressure; network stack state; or other contextual signals such as file descriptor usage. The extracted system record data may be formatted and tagged with a timestamp, signed by a TEE, and stored or transmitted alongside other audit data.

The predetermined times at which the system record data is generated may be based on fixed intervals, dynamically defined policies, or event-triggered schedules. For instance, the processing circuitry 130 may be configured to generate system record data every second, every second, or two seconds or five seconds, or according to a tunable time grid that matches the expected granularity of monitoring. In some examples, the timing may be aligned with operational milestones, such as before and after a data processing job, or immediately after the reception of data from the remote entity. The intervals may be chosen based on a trade-off between audit overhead and resolution of forensic visibility. The objective is to ensure sufficient temporal coverage to demonstrate that no system activity occurred outside the observation window undetected. The regular extractions of system record data may enable continuous logging of computing system behavior, including the absence of suspicious or unauthorized events, thereby establishing a verifiable timeline of non-access. The system record data contributes to a dual-confirmed chain of evidence, proving that during each pulse interval, the computing system remained in a known and expected state.

The processing circuitry 130 is further configured to generate first audit data by signing the system record data and the log data by the first TEE. The processing circuitry 130 is further configured to generate second audit data by signing the system record data and the log data by the second TEE. The processing circuitry 130 may transmit the collected system record data and log data to the first TEE and to the second TEE, each of which may internally include an isolated signing routine. Each TEE may possess a cryptographic private key that is accessible only within its secure boundary and protected by the corresponding root of trust as described above. Using its respective private key, each TEE may generate a digital signature over a structured data package that includes the log data and the system record data, optionally combined with metadata such as timestamps, version identifiers, or policy tags. This signature process may follow standard algorithms such as ECDSA, RSA, or EdDSA, depending on the platform and the available root of trust provisioning.

In some examples, the signature generated by the TEE may serve to prove both the authenticity and the integrity of the audit data. The audit data package, once signed, becomes tamper-evident: any post-signature modification of the log data or system record data would result in an invalid signature during verification. The signed audit data generated by the first TEE may reflect the perspective and policies of the host entity, while the signed audit data generated by the second TEE reflects those of the remote entity. By creating and maintaining dual, independently signed audit streams from each TEE, the apparatus 100 enables later comparison, validation, and anomaly detection with cryptographic assurance. This dual-signature setup ensures that both operational context (captured in the system record data) and activity traces (captured in the log data) are verifiably preserved under the respective trust domains.

The processing circuitry 130 is further configured to transmit the first and the second audit data to a detection system for data aggregation and anomaly detection. The detection system may perform anomaly detection by analyzing the audit data for signs of tampering, misreporting, or operational irregularities in the monitored computing system. In some examples, the detection system may be configured to detect anomalies based on inconsistency, incompleteness, or conflict in the received first and second audit data. Inconsistency may arise when the log data from one TEE reflects activity (e.g., a file write or network transmission) that is not mirrored or acknowledged in the corresponding data from the other TEE. Incompleteness may be indicated by unexpected temporal gaps in the system record data or missing expected events. Conflict may occur when both TEEs report mutually exclusive claims about how the data from the remote entity was handled. Such anomalies may be indicative of compromised TEEs, faulty logging mechanisms, or unauthorized system-level activity that undermines the integrity guarantees of the dual-TEE audit process.

The transmission of audit data to the detection system allows for independent, cross-verifiable analysis and supports automated escalation, such as triggering fallback measures or generating integrity confirmations. The detection system, by comparing independently signed views of system behavior, enables robust and transparent trust assessment between the host and remote entities.

In some examples, the detection system may be implemented by an external apparatus, such as an apparatus 200, which may be configured as a distributed ledger system or another independently verifiable integrity assessment platform that aggregates and verifies the first and second audit data across multiple computing systems or tenants. In other examples, the detection system may be partially or fully implemented by the apparatus 100 or the computing system itself, for instance as a local integrity verification agent that preliminarily detects anomalies before forwarding audit data to an external auditor or aggregation node. This flexibility in implementation supports both decentralized and centralized trust models depending on deployment constraints and the operational relationship between the host entity and the remote entity.

The described technique enables verifiable and tamper-resistant auditing of activities performed within the computing system in response to data received from the remote entity. By instantiating the two TEEs, one operated by the host entity and the other by the remote entity, and independently generating audit data within each of them, mutually isolated and cryptographically verifiable views of the same system behavior are established. This dual-signature mechanism provides a trustworthy record of both log data and point-in-time system record data, each of which is cryptographically signed by a distinct TEE, thereby enabling a reliable comparison of perspectives without relying on a single party's integrity. The result is an independently attestable audit trail that reflects how data was accessed, processed, and transmitted within the system.

Furthermore, the described technique provides for real-time or periodic monitoring of predefined activities such as file access operations, system call execution, and network interactions, as well as consistent generation of system record data at predetermined intervals. These capabilities support detection of subtle or coordinated anomalies such as hidden data exfiltration, unauthorized process behavior, or partial log omissions. The ability to correlate monitored signals into structured audit data and transmit the resulting signed outputs to an external detection system enables integration with anomaly detection and forensic workflows, including deployments within distributed ledger systems. This architecture supports deployment scenarios where operational integrity must be provable across trust boundaries, such as outsourced compute services or collaborative chip design pipelines.

In some examples, the processing circuitry 130 may be further configured to transmit the first audit data to a first storage and the second audit data to a second storage. The first and second storage may be implemented as distinct physical or logical storage units or, in some examples, may share the same storage infrastructure while maintaining separate write domains. For example, the storage may reside within the computing system itself, be integrated in the apparatus 100, or be externally hosted by independent systems or services. This may support verification, access control, and redundancy requirements. In some examples, the first and the second storage are write-once, read-many (WORM) storage systems. The storage systems may be physically or cryptographically constrained such that once audit data is written, it cannot be modified or deleted. By storing the audit data in WORM systems, the architecture supports secure evidence retention, post-incident forensic analysis, and regulatory compliance, especially in environments where mutually distrusting parties (such as a chip design customer and a foundry) require independently verifiable records of access and execution events.

In some examples, the processing circuitry 130 may be further configured to request attestation of the first TEE from a first attestation server and attestation of the second TEE from a second attestation server. In some examples, attestation may refer to a cryptographic integrity verification process whereby the TEE produces a signed attestation report that confirms the identity and internal state of the TEE to an external verifier (such as apparatus 300, see below). This report may include measurements of the software loaded inside the TEE (such as cryptographic hashes of code and configuration), identifiers of the underlying hardware, and integrity proofs derived from a root of trust embedded in the platform. The report may be signed by a private key provisioned to the TEE at manufacturing or enrollment time. The verifier, which may be implemented as an attestation server, may validate this signature using the corresponding public key and confirm that the measurements match an expected configuration. This enables the verifier to determine whether the TEE is genuine, unmodified, and operating in a known-good state. The processing circuitry 130 may be configured to request such attestation from two different attestation servers: a first attestation server for the first TEE operated by the host entity, and a second attestation server for the second TEE operated by the remote entity. Each attestation server may verify its respective TEE independently, based on distinct root-of-trust anchors, measurement baselines, or vendor-provided reference values. For instance, if the computing system is operated by a foundry and executes sensitive design data from a customer inside the second TEE, the customer may operate the second attestation server to remotely verify that the second TEE has launched correctly and has not been tampered with. Likewise, the host may validate the first TEE using its own attestation infrastructure. This separation supports bilateral assurance in scenarios involving multi-party trust boundaries.

In some examples, the processing circuitry 130 may be further configured to receive a first attestation result from the first attestation server indicating whether the first TEE meets integrity requirements. In some examples, the processing circuitry 130 may be further configured to receive a second attestation result from the second attestation server indicating whether the second TEE meets integrity requirements. In other words, each attestation result may represent a determination by the respective attestation server of whether the corresponding TEE meets predefined integrity requirements. These requirements may include successful verification of a cryptographically signed attestation report, comparison of measured software hashes against a trusted baseline, validation of firmware or configuration states, and confirmation that the TEE is running in an expected, non-modified environment. The attestation result may be expressed as a signed confirmation, a Boolean signal, or a structured trust report indicating the outcome of the integrity verification.

The processing circuitry 130 may use the received attestation results to establish a basis of trust for the ongoing monitoring and audit processes. For example, if the first attestation result indicates that the first TEE operated by the host entity is in a trusted state, the processing circuitry 130 may treat subsequent audit data from that TEE as reliable. Likewise, a positive second attestation result for the second TEE, operated by the remote entity, may ensure the remote party that its data will be processed in a verified, isolated environment. If either attestation result indicates a failure, further actions, such as quarantining audit data, triggering fallback logic, or raising alerts, may be initiated to contain potential compromise. This enables the system to establish mutual attestation and trust evaluation prior to and during the audit data lifecycle.

In some examples, the processing circuitry 130 may be further configured to transmit the first and second audit data to a fallback system when the detection system detects an anomaly. The fallback system may serve as an integrity-preserving response mechanism in situations where the trustworthiness of either the computing system or one of the TEEs becomes questionable. The fallback system may comprise a fallback TEE, which may be pre-configured in a read-only configuration. The fallback TEE may be isolated from both the first and second TEE. The fallback TEE may be of similar type as the first TEE, second TEE, but it may be instantiated independently and may not be associated with a specific stakeholder. For example, the fallback TEE may be designated for integrity-preserving purposes, such as forensic capture or redundancy. Its read-only configuration may ensure that the fallback TEE may receive and store audit data without performing any alterations, thereby enhancing its resistance to tampering. This configuration may guarantee that audit data collected during or following an anomaly event is preserved immutably and may be subjected to subsequent review, validation, or independent third-party verification. For example, multiple additional TEEs may be used across the system to isolate workloads of different stakeholders or purposes, with one or more fallback TEEs optionally deployed to provide fail-safe, immutable data sinks for logging and recovery scenarios.

The fallback system may function as part of a “sequestration” or “quarantine” mechanism for handling detected anomalies. When inconsistencies or other anomalies are identified by the detection system, such as conflicting audit reports, unexpected log gaps, or integrity failures, the fallback system becomes the designated secure endpoint for capturing the affected audit data without relying on the potentially compromised primary components. The fallback TEE's read-only setting ensures that any data redirected to it remains unaltered and cryptographically verifiable. This architecture allows the system to maintain a provable, tamper-evident record of events even under compromise conditions, enabling downstream verification, remediation, or escalation procedures without depending on trust in the active components that may have failed.

In some examples, the detection system is further configured to trigger automatic sequestration of a compromised attestation server based on anomaly detection. For example, if inconsistencies, conflicts, or other integrity-related anomalies are identified in the audit data or attestation results, the detection system may isolate the affected attestation server from the rest of the verification infrastructure. Sequestration may involve suspending trust in the attestation server, redirecting verification flows away from it, or activating fallback mechanisms such as the read-only fallback TEE. This mechanism ensures that potential sources of untrustworthy attestations cannot influence future verification outcomes and that the system preserves verifiable audit integrity even in the presence of partial compromise.

In some examples, the processing circuitry 130 may be further configured to transmit the first and second attestation results to the detection system for data aggregation and anomaly detection. This enables the detection system to incorporate the integrity status of both TEEs into its broader analytical context. By receiving and evaluating the attestation results alongside the corresponding audit data, the detection system may correlate signs of misbehavior (e.g., audit inconsistencies) with the trustworthiness of the environments that generated them. This supports more accurate and context-aware anomaly detection, such as identifying cases where audit data appears syntactically valid but originates from a TEE that failed attestation. The joint analysis of audit trails and attestation states thereby strengthens the reliability of compromise detection and informs subsequent responses such as sequestration or fallback activation.

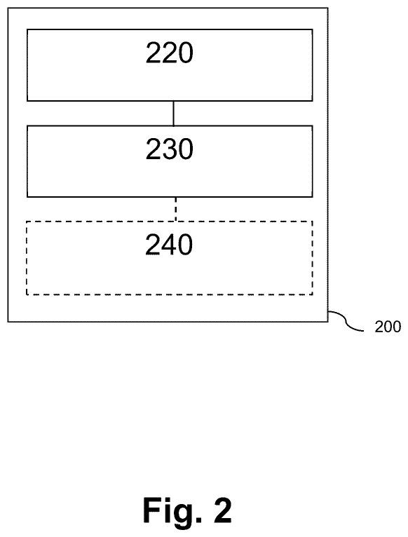

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-10).

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to receive first audit data from a first storage. The first audit data comprises signed system record data and log data generated by a first TEE operated by a remote entity at a computing system. The log data corresponds to activities of the computing system associated with data from the remote entity handled by the computing system. The processing circuitry 230 is further configured to receive second audit data from a second storage. The second audit data comprises signed system record data and log data generated by a second TEE operated by a host entity of the computing system.

The first and second TEE may run on the apparatus 100 and be configured as described above with regards to FIG. 1. The first and second audit data may be generated as described above with regards to FIG. 1.

The first and second storage system may be configured as described above with regards to FIG. 1. For example, the first and second storage may be write-once, read-many (WORM) storage systems.

The processing circuitry 230 is further configured to perform anomaly detection based on the first audit data and the second audit data. The apparatus 200 may implement the detection system as described with regards to FIG. 1 above. In some examples, the processing circuitry 230 may be configured to perform anomaly detection by performing a structured comparison between the first audit data and the second audit data. The first audit data originates from the first TEE operated by the remote entity, and the second audit data originates from the second TEE operated by the host entity. Both audit data sets comprise signed system record data and log data, and are generated independently based on the same underlying computing activities and system states. Anomaly detection may thus involve aligning both audit data sets along a common temporal and procedural axis and verifying that they consistently represent the same predefined activities associated with the data from the remote entity. This may include, for instance, verifying that both TEEs observed the same file accesses, network transmissions, or system calls involving the received data, and that the system state as captured in periodic system record data, such as memory mappings, process hierarchies, or open descriptors, evolves consistently in both records.

In some examples, the apparatus 200 may support deployments involving multiple stakeholder entities being engaged concurrently with the host system and therefore more than two TEEs. For instance, in addition to the first TEE operated by a first remote entity and the second TEE operated by the host entity (e.g., a foundry provider), a third TEE may be operated by a second remote entity. In such scenarios, the host entity may instantiate a dedicated TEE for each stakeholder, thereby enabling the generation of isolated, stakeholder-specific audit data streams for anomaly detection. Each stakeholder's TEE may be paired with a corresponding host-side TEE that mirrors or verifies activities relevant to that specific stakeholder, forming multiple parallel trust zones. For example, when multiple stakeholders require access to the same data set or system operations, the host entity may use a single TEE to generate shared audit data that is cryptographically verifiable by all involved stakeholders. This approach allows for flexible deployment models that support both individualized and shared trust domains while preserving the integrity and attribution of audit records.

In some examples, the anomaly detection may be based on identifying inconsistency, incompleteness, or conflict between the first audit data and the second audit data. Inconsistency may be detected when an event is described differently in the two audit streams. For example, if the first TEE reports that a sensitive file was accessed and transmitted via a network socket, but the second TEE either omits this transmission or logs it under a different process ID or destination, the mismatch may be flagged as an inconsistency. Incompleteness may be detected when a required system record or log entry is missing entirely in one audit stream while present in the other, or when a sequence of expected system record data entries is interrupted by a temporal gap, suggesting tampering or system suspension. Conflict may be detected when the two TEEs report mutually exclusive behaviors, for example, one TEE logs access to a file that the other TEE has marked as deleted or unmountable at that time, or one reports a denial of access while the other shows a successful read.

Further, anomaly detection may further rely on digital signatures to verify the authenticity and freshness of each record, using public keys associated with the respective TEEs. In some implementations, the system may build a unified audit graph or timeline by aligning entries based on process identifiers, timestamps, file paths, or network session identifiers. Discrepancies in that graph, such as missing edges, divergent flows, or unauthenticated segments, may indicate anomalies. This form of structured cross-checking between independently observed audit data enables high-confidence detection of deviations from expected behavior, particularly when one of the TEEs or the host system is compromised or manipulated.

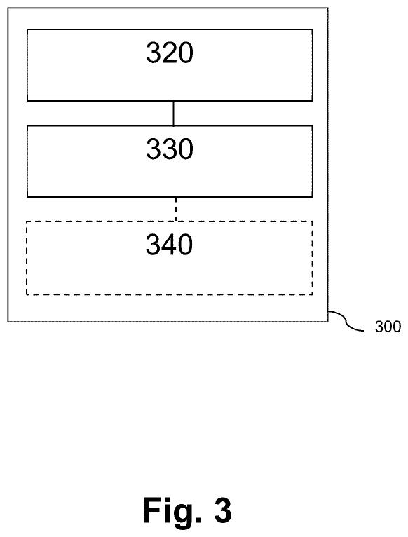

In some examples, the apparatus 200 may be implemented as a distributed ledger system or other public or consortium based verifiable data trust system comprising a plurality of computing nodes configured to collectively store and verify the first and second audit data. For example, apparatus 200 may be implemented as a blockchain-based solution operated by either a public network or a consortium of trusted stakeholders. This implementation may involve a plurality of computing nodes distributed across multiple administrative domains, each participating in a consensus protocol to collectively store, replicate, and validate the first audit data and the second audit data. The distributed ledger, any other similar trusted based system (such as hash based time stamping by a trusted third party), may be structured to immutably record each set of audit data along with its corresponding digital signatures, timestamps, and hash chains, thereby preventing retroactive modification or deletion of records. The ledger's decentralized consensus mechanism may ensure that no single node, including the operator of the host computing system or the remote entity, can unilaterally alter the audit trail without detection. Such a distributed deployment of apparatus 200 may further enhance resilience, transparency, and trust in cross-organizational scenarios, such as those involving sensitive chip design data handled on compute infrastructure managed by the host entity. For example, in a semiconductor foundry context, the audit data generated by the apparatus 100 (i.e., the computing system running the TEEs and audit agents) may be cryptographically verified and recorded by apparatus 200 nodes operated by the design customer, the infrastructure provider, and possibly an independent auditor (see FIG. 3).

This approach not only ensures long-term integrity of the audit trail but also supports independent attestation of data handling events by multiple parties, even in environments where mutual trust is limited. The described technique enables independent, verifiable monitoring of sensitive data usage by aggregating audit data from two mutually distrusting TEEs, one operated by the remote entity and one by the host, thereby ensuring tamper-resistant oversight from both perspectives. This dual-source validation supports transparent and provable accountability for system behavior related to the handled data.

In some examples, the processing circuitry 130 may be further configured to trigger rerouting of the first and second audit data and a first and second attestation results to a fallback server if an anomaly is detected. The fallback system comprising a fallback TEE and being configured in a read-only configuration. The fallback server may be configured as a secure system of last resort and including the fallback TEE operating in a read-only configuration to ensure that no modifications to the received audit or attestation data can occur. The fallback server may be predefined in the system configuration and isolated from regular operations, such that it provides a resilient and trustworthy failover destination if the integrity of the detection system or its associated attestation servers is compromised. The fallback server may be a dedicated backup system configured as part of the immutable setup of the detection infrastructure. Upon triggering by the detection system, the fallback mechanism may serve to preserve continuous audit data capture and validation, ensuring that even in the presence of compromised components, audit trail integrity is maintained. The fallback TEE in the fallback server acts as a neutral and tamper-resistant receiver of audit records and attestation results, which may later be reviewed by external parties or integrated into meta-layer reconciliation.

In some examples, the processing circuitry 130 may be further configured to receive first and second attestation results from respective attestation servers and correlate the attestation results with the first and second audit data to detect anomalies. The correlation of these attestation results with the corresponding first and second audit data may be performed to detect anomalies in system behavior or trustworthiness. This correlation enables the apparatus 200 to identify situations where audit data appears consistent at first glance, but the integrity of the underlying TEE environments cannot be confirmed due to failed or suspicious attestation results. For instance, if the audit data from a TEE appears complete but the corresponding attestation reveals that the TEE was not operating with the expected code or configuration, the system may flag a trust violation. Such joint evaluation of audit trail and attestation integrity may increase the robustness of anomaly detection and ensures that falsified or untrustworthy data cannot be used to mask malicious activity.

In some examples, the processing circuitry 230 may be further configured to verify a network topology comprising network devices and interconnections of the computing system based on signed topology data generated by the computing system. For example, the network topology may refer to a structured representation of all physical or logical nodes in the network of the computing system, including routers, switches, servers, endpoints, and connections among them, that defines how data flows and which components are involved in communication with the computing system. The network topology may comprise device identifiers, port mappings, communication protocols, and connectivity paths. The topology data may be generated periodically or on-demand by the computing system, for instance by a discovery daemon or audit agent, and may be signed using the private key of a TEE or cryptographic key associated with a hardware security module to ensure integrity and authenticity.

The verification of this network topology may be performed by comparing the received signed topology data against expected baseline configurations or known network states. The processing circuitry 230 may use cryptographic signature checks to validate that the topology data indeed originated from a trusted source within the computing system, and was not tampered with during transmission. It may also analyze the structure of the network graph to identify inconsistencies, such as unauthorized devices, unexpected interconnections, or missing links, by matching the declared topology against known configurations or access control policies. This verification may support the anomaly detection capabilities of the apparatus, as deviations from the expected network structure may signal compromised components or the presence of rogue devices.

Such network topology verification may serve as a foundational element for trust evaluation and infrastructure auditing in security-sensitive deployments. For example, the presence of unregistered network interfaces, unauthorized connections between virtual machines, or altered routing paths could invalidate the trustworthiness of audit data. By embedding cryptographically verifiable network state information into the broader audit and attestation framework, the apparatus 200 ensures that both data flow and system interconnectivity are transparently accounted for, enabling secure aggregation and interpretation of audit data across complex distributed environments.

In some examples, the anomaly detection may include detecting a presence of unauthorized devices or connections based on the verified network topology. For example, after the network topology of the computing system has been verified using cryptographically signed data, the processing circuitry 230 may compare the actual, signed topology against an expected configuration that reflects the known and authorized state of the system. If the topology verification reveals nodes or links that were not declared, registered, or authorized, such as an unknown server connected to an internal switch, or an unexpected lateral communication path between enclaves or subnets, these discrepancies may be flagged as anomalies. Such anomalies may indicate attempts to introduce rogue hardware into the environment, to bypass audit boundaries, or to exfiltrate data through unintended channels. By performing this comparison as part of the anomaly detection workflow, the system not only ensures the correctness of recorded audit data, but also protects the underlying infrastructure from stealthy manipulation or circumvention. This capability may be particularly valuable in sensitive deployments such as semiconductor foundries or cloud datacenters, where control over physical and virtual network layout is critical for maintaining confidentiality and integrity of high-value computation.

In some examples, the processing circuitry 230 may be further configured to store a signed integrity confirmation generated by an external auditor (see for example apparatus 300 of FIG. 3). The integrity confirmation indicating a point-in-time presence of aggregated audit data. For example, the signed integrity confirmation may be a cryptographically protected data object that records a point-in-time verification of the presence, consistency, and completeness of aggregated audit data. The signed integrity confirmation may include metadata, cryptographic digests, timestamps, and a digital signature generated by a verification authority such as an external auditor. The processing circuitry 230 may periodically provide the external auditor (see for example apparatus 300), who may be a compliance authority, a regulator, or a delegated oversight service, with hashes or summaries of the aggregated audit data. Upon verification of completeness, consistency, and absence of anomalies, the external auditor may then issue a digital signature over a digest or metadata summary, constituting the integrity confirmation.

This mechanism may enable a verifiable and tamper-evident declaration that, at a specific time, the detection system or meta-layer had received and processed a complete and consistent set of audit data from both the first and second TEEs. The signature of the external auditor may ensure that the confirmation is anchored to a trusted third party, separate from the operators of the TEEs or the detection system itself. This signed confirmation may serve as a timestamped, cryptographically verifiable snapshot of the audit state, providing a legal or regulatory assurance that the system was operating transparently and without anomaly at that point in time.

This confirmation may be stored in a write-once-read-many storage and/or appended to a distributed ledger structure, thereby forming an immutable historical record. In the context of secure multiparty environments such as foundry operations, cloud federations, or industrial IP protection settings, this process may strengthen trust by providing independent validation that the audit data reflects a true and untampered view of system behavior at a specific point in time.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-10).

FIG. 3 illustrates a block diagram of an example of an apparatus 300 or device 300. The apparatus 300 comprises circuitry that is configured to provide the functionality of the apparatus 300. For example, the apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the apparatus 300, in conjunction with the interface circuitry 320. For example, the interface circuitry 320 is configured to exchange information, e.g., with other components inside or outside the apparatus 300 and the storage circuitry 340. Likewise, the device 300 may comprise means that is/are configured to provide the functionality of the device 300.

The components of the device 300 are defined as component means, which may correspond to, or implemented by, the respective structural components of the apparatus 300. For example, the device 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the apparatus 300. Features described in connection with the apparatus 300 may thus likewise be applied to the corresponding device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The apparatus 300 or device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 330 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

In some examples, the apparatus 300 may be operated by an independent auditor, regulatory authority, or compliance entity. This deployment enables a neutral and trusted third party to verify that the audit data and attestation results generated independently by the first and second TEEs (for example operated on the apparatus 100 of FIG. 1), and aggregated and cross-checked by the detection system (for example, apparatus 200 in FIG. 2), provide a faithful and verifiable record of the computing system's behavior. As previously described, both audit data sets comprise signed system record data and log data capturing how data from the remote entity was handled, and may be validated against respective attestation results to ensure TEE integrity. Apparatus 300 may thus operate downstream of these systems and deliver a final external verification step, issuing signed integrity confirmations that attest to the completeness, consistency, and trustworthiness of the recorded data, and enabling long-term, tamper-evident traceability.

Such a configuration may be relevant in scenarios involving multiple stakeholders with limited mutual trust. For example, in a semiconductor foundry context, apparatus 300 may be controlled by the chip design customer and verify that their proprietary design data, processed on host infrastructure, was only accessed and handled in conformance with contractual and technical guarantees. Similarly, in cloud-based environments handling sensitive biomedical or financial data, apparatus 300 may serve as an external oversight mechanism confirming that no unauthorized access or manipulation occurred, even in cases where the cloud provider hosts both the computing system and the detection infrastructure. In multi-party computation frameworks, apparatus 300 may function as a decentralized arbiter ensuring that all parties can independently validate the integrity of data access, processing paths, and infrastructure behavior, using jointly trusted audit trails and attestation results.

The processing circuitry 330 is configured to request first audit data from a first storage. The first audit data comprises signed system record data and log data generated by the first TEE operated by the remote entity at a computing system. The log data corresponds to activities of the computing system associated with data from the remote entity handled by the computing system. The processing circuitry 330 is further configured to request second audit data from a second storage. The second audit data comprises signed system record data and log data generated by the second TEE operated by the host entity of the computing system.

The first and second TEE may run on the apparatus 100 and may be configured as described above with regards to FIG. 1. The first and second audit data may be generated as described above with regards to FIG. 1.

The first and second storage system may be configured as described above with regards to FIG. 1. For example, the first and second storage may be write-once, read-many (WORM) storage systems.

In some examples, the processing circuitry 330 may be further configured to verify the integrity of the first and second storages by checking for tampering or unauthorized modifications. For example, the processing circuitry 300 may access metadata or cryptographic markers associated with the storage systems, such as hash chains, immutable logs, or digital signatures. The processing circuitry 330 may compare cryptographic hashes of the current storage contents against expected values or verify that no new, out-of-sequence, or retroactively altered entries have appeared. For example, the processing circuitry 330 may also validate that the storage's audit data matches independently received digest summaries or snapshots (e.g., those included in signed integrity confirmations).

For instance, if an attacker managed to overwrite WORM-like storage by exploiting hardware or firmware flaws, this may compromise the evidentiary value of the logs. By actively verifying that the storage itself has not been manipulated, the processing circuitry 330 ensures that the audit data reflects an authentic and complete account of system behavior, thereby reinforcing end-to-end trust in the monitoring and attestation infrastructure. This may ensure that the audit data has not been altered after being written and before being verified.

The processing circuitry 330 is further configured to verify the first and second audit data based on their respective digital signatures and integrity constraints. For example, verifying the first and second audit data comprises verifying the digital signatures of the system record data and log data using public keys associated with the respective TEEs. For example, the processing circuitry 330 may obtain the public keys that correspond to the first and second TEEs. These keys may be provisioned as part of a secure enrollment process or distributed by a trusted certificate authority. Using these public keys, the processing circuitry 330 verifies the digital signatures attached to each portion of the audit data, namely, the system record data and the log data, generated by the respective TEEs. The signature verification confirms that the audit data originated from a genuine TEE and was not altered after signing. This provides cryptographic assurance of data provenance.

For example, the processing circuitry 330 may apply further integrity constraints to assess whether the audit data follows expected structural and temporal rules. For example, the integrity check may validate that the log entries are chronologically ordered, that hash chains linking individual records are unbroken, and/or that expected fields (e.g., timestamps, process identifiers, audit tags) are complete and internally consistent. These constraints ensure that the audit data not only originates from an authentic source, but also has not been partially deleted, re-ordered, or selectively redacted. The signature verification and integrity constraint validation may provide a robust foundation for detecting tampering and confirming the trustworthiness of the audit trail.

In some examples, the processing circuitry may be further configured to verify the system record data to detect temporal gaps. These system record data entries, which originate from the first and second TEEs respectively, represent periodic system records of the computing system's state, such as memory maps, process trees, open file descriptors, or network connections as described above with regards to FIG. 1. Each entry is timestamped and cryptographically signed, forming a sequence of time-stamped state captures. To verify the completeness and continuity of this sequence, the processing circuitry 330 may analyze the timing and order of the received system record data. For example, the processing circuitry 330 may check whether the intervals between consecutive entries are consistent with the expected schedule, e.g., a system record every 1 or 5 seconds, as may be predefined in the audit configuration. If the processing circuitry 330 detects an unexplained gap between timestamps (e.g., missing entries or intervals that exceed the permitted maximum), it may flag this as a temporal anomaly. Such gaps could indicate system suspension, tampering, selective omission, or delayed data injection, and are therefore highly relevant for assessing audit integrity. This verification step strengthens anomaly detection by not only checking the content of audit data, but also validating that the sequence itself is temporally coherent and unbroken, an essential property for traceability and forensic confidence.

The processing circuitry 330 is further configured to request a first attestation result attesting the integrity of the first TEE and a second attestation result attesting the integrity of the second TEE. For example, the processing circuitry 330 may be further configured to receive the first attestation result from the first attestation server indicating whether the first TEE meets integrity requirements. In some examples, the processing circuitry 330 may be further configured to receive the second attestation result from the second attestation server indicating whether the second TEE meets integrity requirements. As described with regards to FIG. 1, each attestation result may represent a determination by the respective attestation server of whether the corresponding TEE meets predefined integrity requirements. These requirements may include successful verification of a cryptographically signed attestation report, comparison of measured software hashes against a trusted baseline, validation of firmware or configuration states, and confirmation that the TEE is running in an expected, non-modified environment. The attestation result may be expressed as a signed confirmation, a Boolean signal, or a structured trust report indicating the outcome of the integrity verification.

The processing circuitry 330 is further configured to verify the first and second attestation results. The first and second attestation results may originate from authorized attestation servers and confirm the reported integrity states of the corresponding trusted execution environments. For example, each attestation result may include a digital signature generated by the attestation server that issued the result, a reference to the measured configuration of the TEE, and an outcome indicator representing whether the TEE satisfies predefined integrity requirements. The verification may include checking the authenticity of each result by validating the digital signature against a trusted public key associated with the respective attestation server. For example, the processing circuitry 330 may evaluate the contents of each attestation result to determine whether the reported configuration of the TEEs matches an approved or expected baseline. This may involve comparing measurement values, such as cryptographic hashes of loaded code and configuration parameters, against stored reference values or policy thresholds. If the verification succeeds, the processing circuitry 330 may treat the attestation result as valid evidence of platform integrity. Otherwise, the result may be flagged as untrusted, withheld from further aggregation, or trigger an anomaly response, such as activating a fallback system or halting further audit evaluation.

In some examples, the processing circuitry 330 may be further configured to correlate the verified audit data with the attestation results to detect integrity violations or inconsistencies. For instance, even if audit data appears complete and correctly signed, its credibility may be undermined if the corresponding attestation result indicates that the trusted execution environment was operating in a modified or unauthorized state at the time the data was generated. For example, an attestation result confirming a trusted state may not suffice if the associated audit trail reveals activities that contradict expected behavior. The correlation process therefore aligns the temporal and contextual metadata of the audit data, such as timestamps, process identifiers, or configuration hashes, with the integrity indicators contained in the attestation results, enabling a higher-confidence judgment about whether the trusted execution environments were functioning as claimed when recording the observed system behavior.

This joint evaluation may involve checking whether the signed measurement values in the attestation reports match those used to generate the audit records, whether the timing of the attestation falls within the operational window of the audit data, and whether there is consistency between what the TEEs claim to have observed and what their integrity posture reflects. If discrepancies are found, such as valid audit data generated during a period when the TEE was not in an approved state, then the system may flag such cases as integrity violations. This correlation may enhance the overall robustness of the verification process by ensuring that both data integrity and platform trustworthiness are evaluated together, thereby preventing the misuse of falsified or improperly generated audit records.

In some examples, the processing circuitry 330 may be further configured to generate a verification result based on the verified audit data and attestation results. The verification result may indicate that access to data handled by the computing system was limited to entities authorized by the remote entity. For example, the verification result may serve as a final assessment that summarizes whether the data handled by the computing system, such as intellectual property, design files, or other sensitive assets provided by the remote entity, was processed and accessed exclusively by entities that were pre-authorized or within the trust boundaries defined by the remote entity. To this end, the processing circuitry 330 may assess whether all recorded system activities (as reflected in the signed and validated log data and system records) were carried out by processes and users operating under known and authorized configurations and whether the TEEs responsible for enforcing isolation and logging were themselves attested to be in a trusted state throughout the relevant time period.

The generation of the verification result may comprise cross-referencing observed access events in the audit trail, such as file reads, process executions, or outbound transmissions, with access control policies, entity identifiers, and expected workflows approved by the remote entity. In some examples, the result may further take into account the successful validation of both attestation results, indicating that both the first and second TEEs were running unmodified and policy-compliant software. If all evidence supports the conclusion that the sensitive data remained confined to approved execution paths and trusted environments, the processing circuitry 330 may generate a verification result affirmatively confirming such compliance. This verification result may be used for audit reporting, regulatory submission, or contractual assurance between stakeholders, ensuring that control over sensitive data was maintained throughout its lifecycle in the host computing system.

The above described technique may enable an external verification system to independently validate both the integrity of secure execution environments and the authenticity of audit trails generated within those environments. By requesting and verifying audit data and attestation results from two distinct TEEs, one operated by the host entity and one by the remote entity, the apparatus 300 supports a cross-verification process that is resilient to unilateral tampering or compromise. This separation of duties and trust domains allows a neutral verifier to reconstruct and assess the behavior of the computing system from independently captured records, without relying solely on the statements or configurations provided by the system operator. Such architecture supports high-assurance oversight and fosters transparency in sensitive data-handling scenarios, including collaborative chip design workflows, secure cloud operations, and cross-border regulatory compliance.

In some examples, the processing circuitry 330 may be further configured to generate a signed integrity confirmation indicating a point-in-time presence of the audit data and transmit the signed integrity confirmation to a detection system for storage. The detection system ma may be implemented by the apparatus 200 as described above with regards to FIG. 2. The signed integrity confirmation may encapsulate metadata or cryptographic summaries derived from the verified audit data, such as hashes, digests, or audit graph identifiers, and may be signed using a digital signature issued by the apparatus 300 itself, acting in the role of a verifier. The integrity confirmation may serve as a tamper-evident statement that, at a specific point in time, the processing circuitry 330 successfully received and validated the first and second audit data originating from the respective TEEs described with respect to FIG. 1, and that such audit data was complete, authentic, and free from detectable anomalies. This process complements the attestation verification and audit correlation steps already described, forming a final, externally verifiable record of system trustworthiness.

In some examples, the signed integrity confirmation is stored in at least one of a write-once-read-many storage system or a distributed ledger system. For example, the signed integrity confirmation may be transmitted to the detection system implemented as distributed ledger system for persistent storage. The stored integrity confirmation may be used as a historical trust beacon, a cryptographic checkpoint attesting to the correctness of system behavior at the time of audit. For example, the integrity confirmation may be periodically appended to the WORM storage structure or incorporated into a distributed ledger as described above. This mechanism supports continuous compliance verification and strengthens trust in scenarios where third-party validation of secure computation and data handling is required, such as in multi-tenant semiconductor foundries or regulated data centers.

In some examples, the signed integrity confirmation may comprise a hash of the stored audit data. In some examples, the signed integrity confirmation may comprise a cryptographic hash that represents the stored audit data at a specific point in time. The hash may be calculated over a deterministic and ordered serialization of the verified audit data received from the first and second TEEs, including for example the signed system record data and/or log data, as described with regard to FIG. 1 and FIG. 2. This may comprise applying a secure hash algorithm (e.g., SHA-256 or SHA-3) over a canonicalized form of the audit data, such as a Merkle root of audit entries or a concatenated sequence of normalized record digests. The resulting hash may then be digitally signed by the processing circuitry 330 using a private key, thereby forming a tamper-evident statement that cryptographically anchors the state of the audit data.

By embedding the hash in the signed integrity confirmation, it enables later recipients, such as the detection system (apparatus 200) or an external compliance auditor, to verify that the audit data remained unchanged since the time the confirmation was generated. If the audit data were modified, even in a single byte, the hash would no longer match, and the confirmation would be invalidated. This approach ensures data immutability and integrity over time and enables efficient verification of large audit datasets without re-transmitting the full content. The use of a cryptographic hash thus provides both compactness and strong cryptographic binding between the audit data and the signed confirmation.

In some examples, the processing circuitry 330 may be further configured to verify network topology information based on signed topology data and identify inconsistencies or unauthorized devices. For example, the network topology may refer to a structured representation of all physical or logical nodes in the network of the computing system, including routers, switches, servers, endpoints, and connections among them, that defines how data flows and which components are involved in communication with the computing system. The network topology may comprise device identifiers, port mappings, communication protocols, and connectivity paths. The topology data may be generated periodically or on-demand by the computing system, for instance by a discovery daemon or audit agent, and may be signed using the private key of a TEE or cryptographic key associated with a hardware security module to ensure integrity and authenticity.

The verification of this network topology may be performed by comparing the received signed topology data against expected baseline configurations or known network states. The processing circuitry 330 may use cryptographic signature checks to validate that the topology data indeed originated from a trusted source within the computing system, and was not tampered with during transmission. It may also analyze the structure of the network graph to identify inconsistencies, such as unauthorized devices, unexpected interconnections, or missing links, by matching the declared topology against known configurations or access control policies. This verification may support the anomaly detection capabilities of the apparatus, as deviations from the expected network structure may signal compromised components or the presence of rogue devices.

Such network topology verification may serve as a foundational element for trust evaluation and infrastructure auditing in security-sensitive deployments. For example, the presence of unregistered network interfaces, unauthorized connections between virtual machines, or altered routing paths could invalidate the trustworthiness of audit data. By embedding cryptographically verifiable network state information into the broader audit and attestation framework, the apparatus 300 ensures that both data flow and system interconnectivity are transparently accounted for, enabling secure aggregation and interpretation of audit data across complex distributed environments.

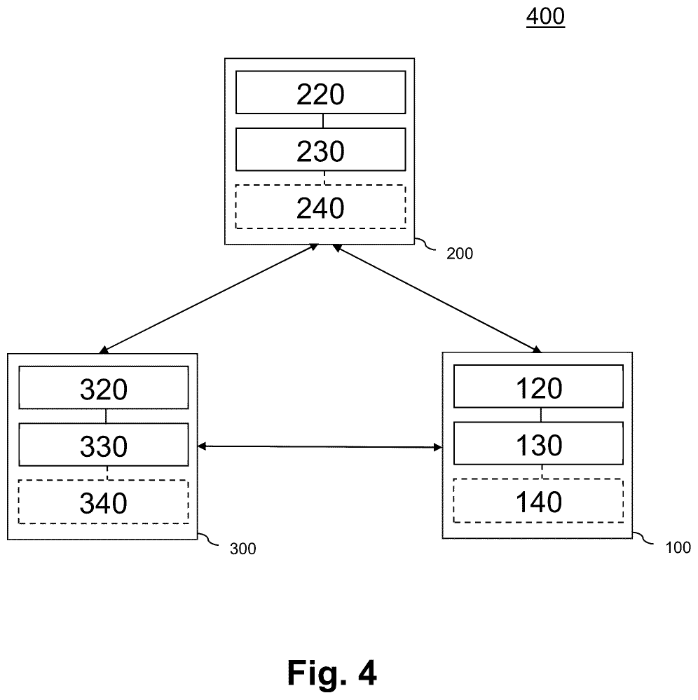

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-10).

FIG. 4 illustrates a system 400 comprising apparatus 100, apparatus 200 and apparatus 300. Apparatus 100, apparatus 200 and apparatus 300 may be communicatively coupled. For example, apparatus 100 may be configured to host the first and second TEE and may be part of the computing system. For example, apparatus 200 may be configured to operate the detection system and apparatus 300 may be configured to operate the external auditor.

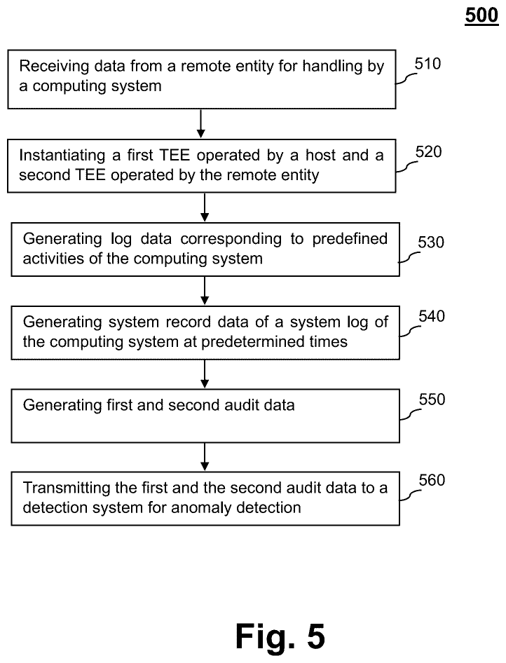

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-10).

FIG. 5 illustrates a flowchart of an example of a method 500. The method 500 may, for instance, be performed by an apparatus as described herein, such as apparatus 100. The method 500 comprises receiving 510 data from a remote entity for handling by a computing system. The method 500 further comprises instantiating 520 a first trusted execution environment, TEE, operated by a host entity of the computing system and a second TEE operated by the remote entity. The method 500 further comprises generating 530 log data corresponding to predefined activities of the computing system associated with the data from the remote entity. The method 500 further comprises generating 540 system record data of a system log of the computing system at predetermined times. The method 500 further comprises generating 550 first audit data by signing the system record data and the log data by the first TEE, and generate second audit data by signing the system record data and the log data by the second TEE. The method 500 further comprises transmitting 560 the first and the second audit data to a detection system for data aggregation and anomaly detection.

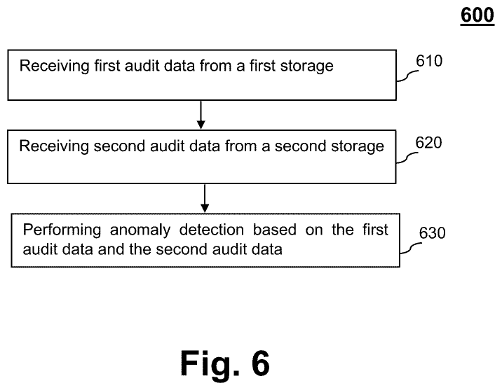

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-10).

FIG. 6 illustrates a flowchart of an example of a method 600. The method 600 may, for instance, be performed by an apparatus as described herein, such as apparatus 200. The method 600 comprises receiving 610 first audit data from a first storage, the first audit data comprising signed system record data and log data generated by a first trusted execution environment operated by a remote entity at a computing system, the log data corresponding to activities of the computing system associated with data from the remote entity handled by the computing system. The method 600 further comprises receiving 610 second audit data from a second storage, the second audit data comprising signed system record data and log data generated by a second TEE operated by a host entity of the computing system. The method 600 further comprises performing 630 anomaly detection based on the first audit data and the second audit data.

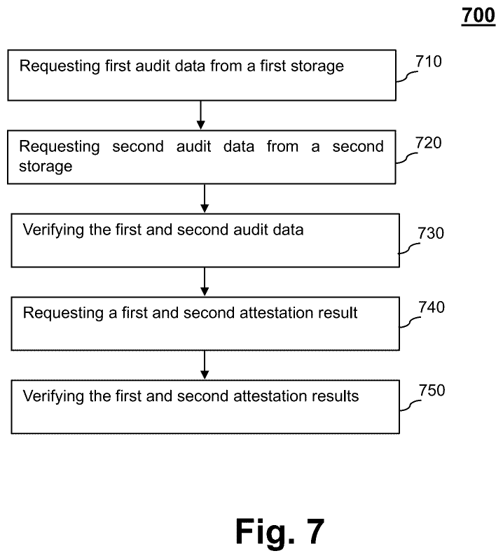

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-10).

FIG. 7 illustrates a flowchart of an example of a method 700. The method 700 may, for instance, be performed by an apparatus as described herein, such as apparatus 300. The method 700 comprises requesting 710 first audit data from a first storage, the first audit data comprising signed system record data and log data generated by a first trusted execution environment operated by a remote entity at a computing system, the log data corresponding to activities of the computing system associated with data from the remote entity handled by the computing system. The method 700 further comprises requesting 720 second audit data from a second storage, the second audit data comprising signed system record data and log data generated by a second trusted execution environment operated by a host entity of the computing system. The method 700 further comprises verifying 730 the first and second audit data based on their respective digital signatures and integrity constraints. The method 700 further comprises requesting 740 a first attestation result attesting the integrity of the first trusted execution environment and a second attestation result attesting the integrity of the second trusted execution environment. The method 700 further comprises verifying 750 the first and second attestation results.

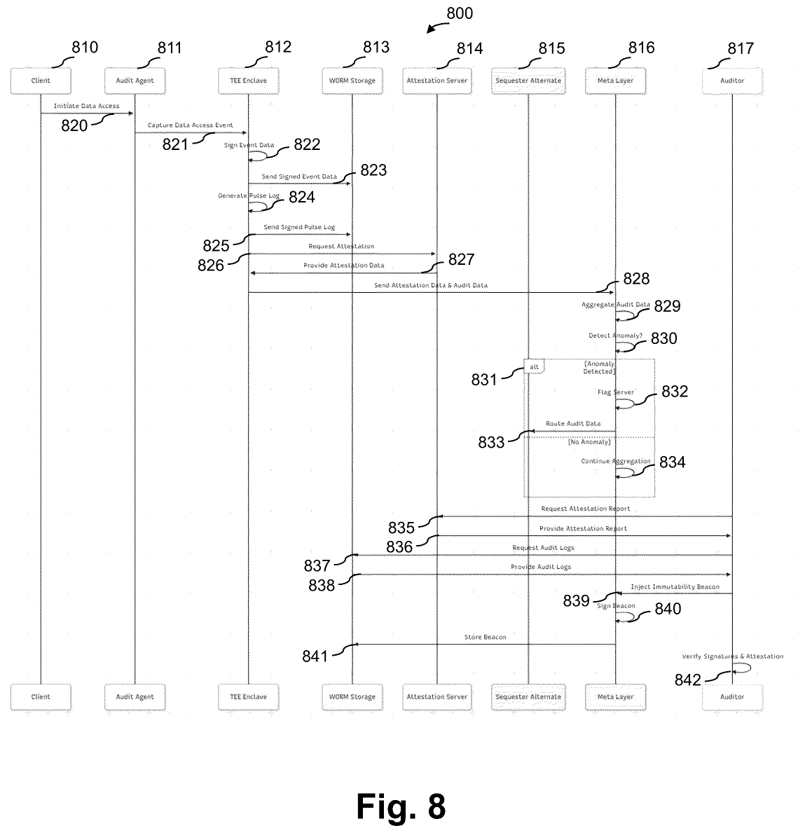

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIGS. 8-10).

### Further Examples

As described above, in a foundry-model enterprise environment where one organizational host entity unit provides compute services (e.g., Intel Foundry) and another develops products (e.g., Intel Products), there may exist a technical requirement to establish provable, cryptographically verifiable separation of identity and access. The host entity must be able to demonstrate to a remote entity (such as the customer Acme Company) with high assurance that its proprietary data has never been accessed by unauthorized personnel or systems. Previous identity and access management platforms may enforce access control policies but cannot produce immutable, non-repudiable evidence that only authorized individuals accessed certain identity-related data, that unauthorized parties never had access outside the permitted scope, or that the corresponding logs have not been modified. Previous approaches based on standard audit logging or conventional access trails are insufficient because they can be bypassed by root-level or out-of-band mechanisms that introduce silent modification or deletion of log entries.

To overcome these deficiencies, the disclosed introduces a verifiable audit logging and verification system based on Trusted Execution Environments (TEEs), hardware-based key storage using secure cryptographic modules such as TPMs or HSMs, and remote attestation protocols. The architecture further introduces the concept of system record data (also referred to as “pulse”) logging, in which the absence of file or network input/output events is itself recorded in a cryptographically signed timeline to create an immutable proof of inactivity. By combining runtime attestation with sealed configuration data and tamper-proof logging, the system enables not only auditability of access events but also cryptographic assurance that no access occurred during a monitored period. A related technical problem arises in distributed environments where multiple systems generate audit data. The challenge lies in unifying event logging and non-access proofs across heterogeneous systems at scale, ensuring that logs from different nodes can be correlated in time and integrity-verified in a decentralized way.

Existing systems do not provide interoperable attestation protocols across heterogeneous TEE implementations, limiting verification to single-platform deployments. Furthermore, distributed logging infrastructures lack intrinsic cryptographic guarantees that log entries from many different sources are complete and untampered. Present tools also struggle with real-time correlation of access events across disparate system boundaries and time domains, which is essential for end-to-end forensic investigations. The technical difficulty may be amplified when attempting to prove not only what happened but what definitively did not happen, provable non-access, within a distributed architecture.

The disclosed solution addresses these limitations by establishing dual or multiple TEEs (for multiple remote parties), each bound to independent trust zones operating on the same physical server. For instance, Acme Company may own a TEE on a given server, and Intel Foundry may simultaneously operate a second TEE on the same platform. Each TEE receives input from that server but enforces complete segregation such that neither party can access the enclave or runtime data of the other. The system defines novel runtime behaviors and enclave interaction methods that ensure data delivery to each enclave is verifiable and free from prior manipulation. This allows the TEEs to serve as cryptographically isolated verification endpoints for trusted logging, event correlation, and audit evidence generation. The architecture provides new methods that make such separation both technically feasible and operationally viable in enterprise settings.

For example, a customer such as Acme may wish to utilize the compute capabilities of Intel Foundry but insists on receiving technical guarantees that non-foundry personnel, such as Intel Products engineers, cannot access or manipulate proprietary design data. Using the system described herein, Intel Foundry deploys a server architecture implementing dual TEEs with sealed configurations and real-time pulse logging. Each access event or absence thereof is cryptographically recorded, signed, and immutably stored. Upon request, Intel can provide Acme with verifiable records of data access events or non-events, proving compliance with strict data separation policies.

The disclosed technique enables cryptographically grounded trust between compute providers and their customers, removing the need for legal constructs or assumptions of good faith. By allowing two or more stakeholders to independently operate trusted execution environments on the same compute node, each with immutably verifiable logging and sealed configuration, the system replaces reliance on trust with hardware-rooted proof. The proposed technique achieves separation of duties in environments that previously relied solely on organizational or contractual boundaries. For example, in cloud service environments, logical trust zones are implemented per customer, and customers rely on the cloud provider to enforce boundary policies. However, in foundry-style environments, where the same entity provides both compute infrastructure and develops its own products, the separation is more difficult to assure. Legal and procedural mitigations cannot eliminate the inherent conflict of interest. The present disclose resolves this technical challenge by providing mutual, independently verifiable trust zones within shared compute resources. Each TEE is protected by a sealed configuration and attestation reports signed by the platform manufacturer. Each trust zone is cryptographically isolated and incapable of manipulating the other's data, logs, or policies. An arbitrary number of trust zones may be instantiated on the same platform to support multiple foundry customers simultaneously. This enables those customers to independently examine the telemetry and policy states of their own enclave and associated data, achieving a level of trust previously unobtainable without bespoke hardware or isolated physical environments.

FIG. 8 illustrates an example of a flowchart 800. The flowchart 800 comprises interactions among a client 810, an audit agent 811, a TEE (for example apparatus 100 in FIG. 1) enclave 812, a write-once-read-many (WORM) storage system 813, an attestation server 814, a sequester alternate 815, a meta-layer apparatus 816 (for example, apparatus 200, see FIG. 2), and an external auditor apparatus 817 (for example, apparatus 300, see FIG. 3). The TEE enclave 812, the WORM storage system 813, and the attestation server 814 may each correspond to the first and/or the second unit, respectively. The flow chart 800 represents a time-ordered sequence of operations conducted during the capture, validation, and integrity verification of sensitive audit data associated with client activity on a computing system (for example, the system of FIG. 1).

The process begins at step 820, where the client 810 initiates access to protected or monitored data. In response, at step 821, the audit agent 811 detects and captures the corresponding data access event. At step 822, the TEE enclave 812 cryptographically signs the captured event data, for example by computing a digital signature over an event record using an internal private key securely provisioned in the TEE. At step 823, the signed event data is transmitted to the WORM storage 813, which ensures tamper-resistant archival. In parallel, at step 824, the TEE enclave 812 generates a pulse log, a time-based snapshot or system trace representing the operational state of the system over a defined interval, and signs the pulse log. At step 825, the signed pulse log is also transmitted to the WORM storage 813.

Attestation is triggered at step 826, wherein the audit agent 811 requests an attestation of the integrity state of the TEE enclave 812 from the attestation server 814. The attestation server 814 may operate as a remote validator, verifying the state of the TEE based on a signed attestation report and a trusted reference baseline. The attestation data is returned to the audit agent step 827. At step 828, the audit agent sends the signed audit data (e.g., the event record and pulse log) and the attestation result to the meta-layer 816 for processing.

At step 829, the meta-layer 816 aggregates the received audit data and attestation information, preparing it for further correlation and integrity analysis. At step 830, the meta-layer 816 performs anomaly detection, which may involve verifying signature correctness, checking for inconsistencies or missing data, evaluating correlations between audit logs and attestation results, and verifying system state conformity. A conditional branch is illustrated at step 831: if an anomaly is detected (step 830), the meta-layer triggers a remediation sequence, beginning with flagging the server for review at step 832 and rerouting the audit data and attestation results to the sequester alternate 815 at step 833. The sequester alternate may include a fallback TEE configured in a read-only or isolation mode, enabling secure investigation. If no anomaly is detected, aggregation continues normally at step 834.

Subsequently, at step 835, the meta-layer 816 issues a request to the attestation server 814 for a detailed attestation report, which is returned at step 836. This report may contain structured integrity evidence including measurement hashes, boot state confirmations, firmware and configuration metadata, or other runtime assertions about the TEE's state. In parallel, at step 837, the meta-layer 816 also requests historical or complementary audit logs from the WORM storage 813. These logs are returned at step 838 and may include previous pulse logs, event records, or system status snapshots needed for continuity verification. To provide an immutable, point-in-time assertion of audit completeness and correctness, the meta-layer 816 generates a signed integrity confirmation at step 839, also referred to as a beacon. This beacon may be signed using a dedicated cryptographic key under the meta-layer's trust domain and includes cryptographic hashes of the received audit data, attestation results, and optionally metadata regarding aggregation time or source systems. The beacon is signed at step 840 and stored back into the WORM storage 813 at step 841, ensuring durable and tamper-evident preservation.

At step 842, the beacon and relevant audit and attestation data are transmitted to the auditor apparatus 817. The auditor may operate independently and is configured to validate the beacon signature, verify audit trail consistency, and ensure that access events on the system were properly monitored and attributed. This final verification stage ensures that audit evidence is not only internally consistent, but also externally confirmed by an independent verification layer.

The above technique provides a Server-Level Proof (individual system integrity), an Enterprise-Level Proof (network/infrastructure integrity), and a Data-Level Proof (information integrity and traceability). The Server-Level Proof focuses on the integrity and trustworthiness of individual systems (apparatus 100), addressing internal system security and auditability. The Enterprise-Level Proof emphasizes the integrity and trustworthiness of the broader network and infrastructure, supporting external system security and auditability. The Data-Level Proof ensures the integrity, provenance, and traceability of data as it traverses the enterprise, enabling consistent verification and attribution throughout the data lifecycle.

The Server-Level Proof (individual system integrity) ensures that even a system administrator with root privileges cannot circumvent auditing. This is achieved through the dual TEE-based provable non-access logging mechanism. The method involves an “auditd”-like process (audit agent) to observe and correlate file input/output with network input/output and immutably log all events. The two TEEs are configured as inter-readable, immutable, cross-verifiable zones, one operated by the infrastructure provider (e.g., Intel Product) and the other by the customer (e.g., Acme Company), thereby creating an independently verifiable audit chain. Hardware-attested, root-resistant server auditing leverages hardware security modules (HSMs) to protect cryptographic keys and isolate audit processes within the TEEs, ensuring that root-level software cannot manipulate logs. The system emits enclave-generated, verifiable pulse logs (also referred to as signed system record data), which periodically scan file and network I/O and include non-events to build a provable timeline of consistent system activity. Remote attestation for server-level audit integrity allows an interested party to verify the TEE's code and configuration by independently validating attestation data against publicly available reference measurements (attestation results). This configuration includes support for a sequester alternate server (also referred to as fallback server), which can be activated based on immutable configuration rules to ensure failover integrity in case of compromise.

The Enterprise-Level Proof (network/infrastructure integrity) makes it possible to prove the presence and absence of all network-connected assets. This may be implemented using distributed, cryptographically verifiable network topology mapping (signed topology data), which provides evidence of existing and non-existing devices in the infrastructure. The architecture supports real-time, cross-system event correlation using decentralized, time-synchronized TEE attestation (audit and attestation result correlation), enabling coherent visibility of system behavior across domains. The system supports provable, immutable infrastructure state reporting via distributed ledger-like structures (e.g., WORM or distributed ledger system) that store state information and cryptographically signed change logs. Device provenance validation is enforced using hardware-rooted mechanisms that ensure the full traceability of device history and physical location, facilitating the detection of unauthorized or rogue hardware.

The Meta Layer (for example apparatus 200) with fast remediation enables connectivity and verification across the environment for immutable proofs. It implements decentralized, cryptographically anchored audit aggregation using a structure similar to a distributed ledger (distributed ledger system), mitigating the risk of manipulated or incomplete audit trails. Auditor-signed, periodic immutability beacons (also referred to as signed integrity confirmations) are injected into this meta-layer to establish a verifiable timeline and prevent retroactive tampering. The architecture further includes automated, policy-driven mechanisms for flagging and isolating compromised servers and redirecting audit streams to the fallback server, ensuring uninterrupted integrity. Anomalies across the environment are detected using federated TEE consensus (federated detection logic across TEEs), which compares independently verified audit data from multiple trusted execution environments to identify inconsistencies or tampering.

In one example scenario, the computing system is deployed to provide verifiable server-level audit integrity based on hardware-isolated logging and independent attestation. The server operated by a representative employee (e.g., Alice) of a computing provider (e.g., Intel Foundry) is equipped with a TEE, a trusted platform module or hardware security module [TPM/HSM], and a secure audit infrastructure. The TEE enclave (e.g., as described for apparatus 100 in FIG. 1) is instantiated by Alice using a signed build configuration, and remote attestation is enabled to allow verification of the enclave state by a dedicated attestation server. Additionally, a fallback system comprising a second TEE in a sequestered alternate server is configured and written into a read-only partition, forming part of the immutable platform configuration. The audit agent on the server is configured to observe file and network I/O operations and to generate periodic signed logs, including pulse logs, which are transmitted to the WORM storage system.

The system further enables logging of application activity and data access operations, with all events signed within the TEE enclave and forwarded to both the local immutable storage and the aggregation system. The configuration prevents any modification or suppression of logging behavior, including the disabling of the pulse generation or changes to the alternate attestation routing. An independent auditor or verifying authority may retrieve and verify the audit data, including confirming the integrity of the attestation results and the correctness of the pulse logs. In the event of a failure or compromise of the primary attestation server, the auditor may retrieve signed integrity confirmations or attestation results from the sequestered alternate server. Because the alternate server is isolated and locked to a fixed configuration, its integrity can be independently verified.

In this architecture, the server operator (e.g., Alice) is unable to interfere with any component of the audit system. The TEE enclave, the audit configuration, and the log transmission mechanisms are protected. Attempts to modify logs in WORM storage, stop the pulse mechanism, or bypass attestation are technically infeasible. The configuration of the sequestered alternate is immutable and not alterable by the system administrator, ensuring root-level resistance and hardware-anchored trust guarantees.

In another example scenario, a customer entity (e.g., Bob from Acme Company) may wish to verify, using immutable audit artifacts, that only authorized employees of a hosting provider (e.g., Intel Foundry) have accessed sensitive data. The infrastructure is deployed such that each computing node includes hardware-based attestation, root-resistant audit isolation using dual TEEs and enclave-generated pulse logs. All audit data is transmitted to the audit aggregation system and stored in both WORM memory and distributed ledgers. The meta-layer includes mechanisms for decentralized anomaly detection, immutability beacons signed by an auditor, and automatic failover routing to a sequestered alternate server if compromise is detected.

Sensitive data from Acme Company is only processed in the secure environment provided by Intel Foundry. Audit agents log all access events (file I/O, network I/O, application usage) and the signed records are transmitted for aggregation. Bob may request attestation results from the TEE attestation servers to validate the enclave integrity. He may inspect signed audit logs stored in WORM memory and review the pulse timeline to confirm that no unlogged or hidden activity occurred. He may further analyze the aggregated audit view across all Foundry servers using the meta-layer, which correlates data across the enterprise.

To demonstrate internal access separation, Bob filters audit logs to confirm that only employees associated with Intel Foundry appear as data handlers, while any access by other entities (e.g., Intel Products) would be detected and flagged. The network topology verification system ensures that all infrastructure devices are accounted for, and that shadow servers or rogue hardware cannot be introduced without detection. Cross-system anomaly detection within the meta-layer flags unauthorized patterns and ensures tamper-resistant infrastructure observation.

Because the audit trail is cryptographically bound and supported by WORM storage and external immutability beacons, Bob may generate compliance and security reports for internal assurance or external regulatory review. These reports are based on data that is immutable, verifiable, and time-anchored. If the system detects compromise of a reporting server, the meta-layer autonomously routes the data to a sequestered alternate system, preserving the continuity and trust of the audit process. This provides Bob with end-to-end confidence that Acme Company's data was handled exclusively and securely by authorized personnel under an architecture supporting provable integrity and accountability.

For example, the system may be configured to generate server-level proofs of individual system integrity by capturing and documenting operating system-level observations in a non-repudiable and cryptographically verifiable manner. Such documentation may persist even in the presence of root-level access by privileged operators, ensuring that audit integrity is preserved independently of administrative authority. The resulting trust proofs may be anchored to external, multi-party verifiers, thereby enabling verification outside of the originating system's administrative control and trust domain.

For example, the TEE may be capable of executing secure processes, accepting data via an application programming interface, and operating on the data in an isolated environment. However, the TEE might not possess native visibility into operating system-level activity and therefore cannot autonomously observe events such as file system access or network activity. Conversely, existing audit and logging services (for example, auditd) may have kernel-level visibility and can capture detailed system events, but these observations are not inherently immutable. System administrators, including those with root access, may be able to alter or erase such records, compromising their evidentiary value.

To address this technological gap, the present approach introduces new methods for combining secure execution with verifiable observation and immutable event tracking. In particular, the system may integrate event monitoring for file input/output operations, network activity, and configuration states with a dual-trust mechanism that resists manipulation by any single privileged actor. Observations are signed within the TEE and persisted in tamper-resistant storage ([e.g., WORM storage system) or cryptographically anchored meta-layers. These guarantees are designed to persist beyond the control of any single organization, cloud service provider, or enterprise trust anchor, thereby enabling audit verification even in adversarial or untrusted administrative contexts.

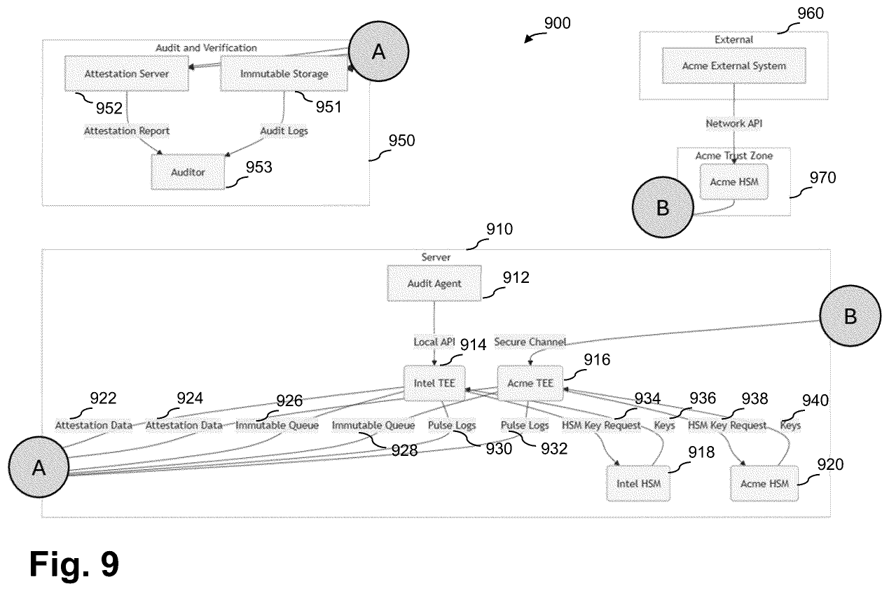

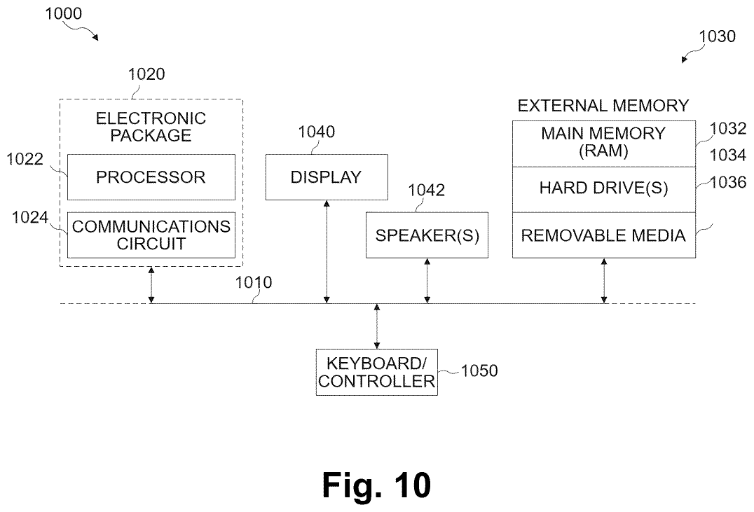

Further details and aspects are mentioned in connection with the examples described above or below. The example shown in FIG. 8 may include one or more optional additional features corresponding to one or more aspects mentioned in connection with the proposed concept or one or more examples described above (e.g., FIGS. 1-7) or below (e.g., FIGS. 9-10).

FIG. 9 illustrates an example system architecture 900 using dual TEEs. The system 900 is designed to support server-level and enterprise-level integrity proofs across distinct trust domains. The components and information flows are consistent with the audit processing architecture described above. The depicted elements may collectively implement functionalities of the audit agent server (apparatus 100), the meta-layer apparatus (apparatus 200), and the external verifier (apparatus 300).

The lower part of the system 900 represents a local server 910, for example operated by Intel Foundry division, comprising an audit agent 912 configured to capture system-level activity such as file access and network communication. The audit agent 912 transmits observed event data via a local API to a first trusted execution environment (Intel TEE 914) and via a secure communication channel to a second trusted execution environment (Acme TEE 916). These TEEs represent isolated trust domains belonging to the host (Intel Foundry) and the remote customer (Acme), respectively.

The Intel TEE 914 and Acme TEE 914 are configured to generate pulse logs 930 and 932, respectively, as periodic snapshots or non-event records documenting system behavior and inactivity. These pulse logs, as well as event logs captured by the audit agent 912, are written to respective immutable queues 926 and 928, preserving audit data in a write-once structure. Attestation data 922, 924 is also generated and signed by each TEE and transmitted for storage and later verification. The TEEs are further configured to generate hardware-backed key requests 934, 938 directed to hardware security modules (HSMs) 918 and 920 operated by Intel Foundry and Acme, respectively. The responses 933, 940 return cryptographically protected key material under conditions that require prior verification of the TEE's identity and integrity.

The upper-left area marked A corresponds to the audit and attestation infrastructure corresponding to Intel Foundry (block 950). This includes an attestation server 952 that receives attestation data from the TEEs, and an immutable storage system 951 for preserving audit logs and pulse logs. An external auditor 953 may access the stored audit logs and attestation reports to perform independent verification. The auditor may validate digital signatures, confirm that the attested TEEs match expected integrity baselines, detect tampering, and ensure pulse log consistency across time intervals.

The upper-right area marked B comprises systems corresponding to the remote customer entity Acme. The external domain 960 includes the Acme External System, which may issue access requests, trigger audit verification, or retrieve logs. The Acme Trust Zone 970 includes an Acme HSM configured to interact securely with the Acme TEE 915 over the secure channel. The Acme HSM 970 allows Acme to anchor key provisioning and audit validation within its own infrastructure, thereby enforcing external accountability and protecting customer trust boundaries.

The architecture as described in FIG. 9 supports cross-verifiable attestation, integrity-preserving log storage, and secure dual-domain audit processing. The combination of TEEs with distinct ownership, tamper-evident log structures, and verifiable external access to attestation and audit data ensures that both the host and the remote customer can independently prove and validate data handling behavior without requiring mutual trust.

The described system architecture implements two distinct TEEs on a single server to enable mutual trust and independently verifiable auditability between collaborating entities, such as the host entity (e.g., Intel Foundry) and a remote entity (e.g., Acme Company). Each TEE is operated under separate administrative control, forming isolated trust zones. The TEE controlled by Acme Company (referred to as the Acme TEE) is configured to receive telemetry configurations from a dedicated Hardware Security Module (HSM), which serves as a secure external gateway. The Acme TEE applies these configurations, such as monitored file paths and network ports, to perform real-time cryptographic hashing of file input/output and network communication events. Each observation is signed and transmitted to an immutable storage queue that is implemented outside the operating system. The Acme TEE signs each event individually and stores the output in a format not modifiable by the host.

The Acme HSM enforces telemetry policies defined by Acme Company, thereby controlling which external systems may write to the event queues and ensuring compliance with strict integrity and provenance constraints. Furthermore, the runtime environment and code of the Acme TEE are subject to remote attestation, allowing independent validation of its operational state by a remote attestation server. The overall configuration, including the secure channel between the Acme TEE and the HSM, bypasses the host operating system entirely and prevents host-level manipulation or observation.

The server also contains the second TEE operated by the host entity (referred to as the Intel TEE), which is responsible for performing audit log processing and integrity verification. The Intel TEE receives data from a privileged audit agent (e.g., a HEPSM-based process that observes file and network activities) and generates cryptographically signed records, including periodic pulse logs (also referred to as system record data). These pulse logs capture the absence of file or network input/output events, thereby creating a verifiable and continuous timeline of system activity. The Intel TEE is configured based on code signed by the hardware manufacturer and stored in a read-only partition. Furthermore, its operational state is sealed to an HSM, and the TEE is subject to remote attestation to establish platform integrity.

In both the Acme and Intel domains, cryptographic keys are managed exclusively within respective HSMs, thereby preventing software-level access to sensitive signing operations. The audit logs and pulse logs are stored in an append-only immutable queue that is inaccessible to the host operating system. This ensures that the records remain tamper-evident and resilient to manipulation, even by a system administrator with root privileges. To provide additional resiliency, the fallback server is included in the system configuration. This server is isolated from the primary attestation infrastructure and is configured to receive and store attestation data in a trusted manner, thereby serving as a fallback validation source in the event of compromise or outage of the primary attestation server.

Together, these components form a hardware-rooted chain of trust anchored in independently attested TEEs, cryptographically isolated HSMs, and append-only audit queues. The system allows auditors to inject signed integrity confirmations (referred to as immutability beacons) into the meta-layer, thereby establishing a verifiable timeline of log generation and closing the gap in retroactive log manipulation. The combination of dual TEEs sequestered alternate attestation, immutable storage, and external verification enables an audit integrity model that transcends platform control and overcomes the limitations of conventional logging and telemetry solutions.

The system described to this point may implement a security architecture that establishes two or more isolated trust zones within a single server. These trust zones are independently controlled by distinct stakeholders, such as a service provider (e.g., Intel Foundry) and a customer (e.g., Acme Company). Each trust zone operates within a separate Trusted Execution Environment (TEE), wherein the TEEs differ in configuration and administrative control. A secure logging mechanism is provided that is capable of writing event data to either TEE while ensuring that neither Alice (representing the server administrator from Intel Foundry) nor Bob (representing Acme) can manipulate or tamper with the resulting logs. Within this structure, Alice may configure her own trust zone to receive and process event data collected through immutable logging mechanisms. The corresponding TEE under her control may support audit functions, telemetry collection, and operational tracking. Simultaneously, Bob can operate a distinct trust zone managed by Acme Company. This trust zone remains isolated from Alice's access privileges and may implement independent verification mechanisms, including attestation, telemetry configuration, and secure key handling, ensuring exclusive visibility and integrity of data flows governed by Acme.

This trust zone architecture may be extended across a larger computing environment comprising a plurality of servers. Each such server may support multiple independent trust zones operated by different stakeholders. In such a distributed deployment, the security model enables each participating entity to maintain verifiable oversight over data events, even in collaborative or shared infrastructure scenarios. Each trust zone is governed by a distinct TEE and associated hardware-rooted integrity mechanisms, such as hardware security modules (HSMs) and remote attestation interfaces.

As implemented, the secure logging system is designed to forward event data to one or more trust zones based on pre-defined policies. The data written into the trust zones may include file input/output activity, network traffic, application process metadata, and telemetry records. Importantly, these logs are immutable and cannot be modified by the system administrator or any other single actor within the platform. The trust zones of the provider (e.g., Intel Foundry) may be configured to collect immutable audit trails and generate structured audit objects. These objects may be further analyzed or reported based on enterprise or regulatory requirements.

Conversely, the customer-controlled trust zones (e.g., Acme Company) enforce strict isolation from the provider infrastructure and enable sovereign audit processes, whereby only the customer can observe and verify the data collected within their domain. This architecture ensures that integrity, provenance, and access tracking remain verifiable and attributable across all stakeholders. When applied to a distributed environment, the system facilitates comprehensive observability and auditability by each participant, establishing verifiable records of data access, data modification, communication activity, and software execution across the enterprise.

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1-8) or below (e.g., FIG. 10).

FIG. 10 illustrates an example of a block diagram of an electronic apparatus 1000 incorporating at least one electronic assembly 100, 200, 300 and/or methods 500, 600 and/or 700 described herein. Electronic apparatus 1000 is-merely one example of an electronic apparatus in which forms of the electronic assemblies 100, 200, 300 and/or methods 500, 600 and/or 700 described herein may be used. Examples of an electronic apparatus 1000 include, but are not limited to, personal computers, tablet computers, mobile telephones, game devices, MP3 or other digital music players, etc. In this example, electronic apparatus 1000 comprises a data processing system that includes a system bus 1010 to couple the various components of the electronic apparatus 1000. System bus 1010 provides communications links among the various components of the electronic apparatus 1000 and may be implemented as a single bus, as a combination of busses, or in any other suitable manner.

An electronic assembly 1020 as describe herein may be coupled to system bus 1010. The electronic assembly 1020 may include any circuit or combination of circuits. In one embodiment, the electronic assembly 1020 includes a processor 1022 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 1020 are a custom circuit, an application-specific integrated circuit (ASIC), or the like, such as, for example, one or more circuits (such as a communications circuit 1024) for use in wireless devices like mobile telephones, tablet computers, laptop computers, two-way radios, and similar electronic systems. The IC can perform any other type of function.

The electronic apparatus 1000 may also include an external memory 1030, which in turn may include one or more memory elements suitable to the particular application, such as a main memory 132 in the form of random access memory (RAM), one or more hard drives 1034, and/or one or more drives that handle removable media 1036 such as compact disks (CD), flash memory cards, digital video disk (DVD), and the like.

The electronic apparatus 1000 may also include a display device 1040, one or more speakers 1042, and a keyboard and/or controller 1050, which can include a mouse, trackball, touch screen, voice—recognition device, or any other device that permits a system user to input information into and receive information from the electronic apparatus 1000.

Further details and aspects are mentioned in connection with the examples described above. The example shown in FIG. 10 may include one or more optional additional features corresponding to one or more aspects mentioned in connection with the proposed concept or one or more examples described above (e.g., FIGS. 1-9).

In the following, some examples of the proposed concept are presented:

Another example (e.g., example 2) relates to a previous example (e.g., example 1) or to any other example, further comprising that the processing circuitry is further to execute the machine-readable instructions to transmit the first audit data to a first storage and the second audit data to a second storage.

Another example (e.g., example 3) relates to a previous example (e.g., example 2) or to any other example, further comprising that the first and the second storage are write-once, read-many storage systems.

Another example (e.g., example 4) relates to a previous example (e.g., one of the examples 1 to 3) or to any other example, further comprising that the detection system is configured to detect anomalies based on inconsistency, incompleteness, or conflict in the received first and second audit data.

Another example (e.g., example 5) relates to a previous example (e.g., one of the examples 1 to 4) or to any other example, further comprising that the processing circuitry is further to request attestation of the first TEE from a first attestation server and attestation of the second TEE from a second attestation server.

Another example (e.g., example 6) relates to a previous example (e.g., one of the examples 4 to 5) or to any other example, further comprising that the processing circuitry is further to receive a first attestation result from the first attestation server indicating whether the first TEE meets integrity requirements, and receive a second attestation result from the second attestation server indicating whether the second TEE meets integrity requirements.

Another example (e.g., example 7) relates to a previous example (e.g., example 6) or to any other example, further comprising that the detection system is further configured to trigger automatic sequestration of a compromised attestation server based on anomaly detection.

Another example (e.g., example 8) relates to a previous example (e.g., one of the examples 5 to 7) or to any other example, further comprising that the processing circuitry is further to transmit the first and second attestation results to the detection system for data aggregation and anomaly detection.

Another example (e.g., example 9) relates to a previous example (e.g., one of the examples 1 to 8) or to any other example, further comprising that the processing circuitry is further to transmit the first and second audit data to a fallback system when the detection system detects an anomaly, the fallback system comprising a fallback trusted execution environment and being configured in a read-only configuration.

Another example (e.g., example 10) relates to a previous example (e.g., one of the examples 1 to 9) or to any other example, further comprising that the system record data comprises point-in-time state information extracted from a system log of an operating system of the computing system.

Another example (e.g., example 11) relates to a previous example (e.g., one of the examples 1 to 10) or to any other example, further comprising that the first trusted execution environment is configured to operate independently from the second trusted execution environment, and each environment is associated with a distinct root of trust.

Another example (e.g., example 12) relates to a previous example (e.g., one of the examples 1 to 11) or to any other example, further comprising that the log data comprises at least one of data access operations, file input/output operations, or network communication events associated with the data from the remote entity.

Another example (e.g., example 13) relates to a previous example (e.g., one of the examples 1 to 12) or to any other example, further comprising that generating the log data comprises monitoring at least one of data access operations, file input/output operations, or network communication events associated with the data from the remote entity.

Another example (e.g., example 14) relates to a previous example (e.g., one of the examples 1 to 13) or to any other example, further comprising that the processing circuitry is further to perform a correlation on the monitored predefined activities of the computing system associated with the data from the remote entity. 15. The apparatus of any one of examples 1 to 14, wherein the second TEE is configured to receive data input via a secure gateway comprising a hardware security module, the hardware security module being provisioned with access control policies defined by the remote entity and operating independently of the host operating system of the computing system.

An example (e.g., example 16) relates to an apparatus comprising interface circuitry, machine-readable instructions, and processing circuitry to execute the machine-readable instructions to receive first audit data from a first storage, the first audit data comprising signed system record data and log data generated by a first trusted execution environment operated by a remote entity at a computing system, the log data corresponding to activities of the computing system associated with data from the remote entity handled by the computing system, receive second audit data from a second storage, the second audit data comprising signed system record data and log data generated by a second TEE operated by a host entity of the computing system, perform anomaly detection based on the first audit data and the second audit data.

Another example (e.g., example 17) relates to a previous example (e.g., example 16) or to any other example, further comprising that the first and second storage are write-once, read-many storage systems.

Another example (e.g., example 18) relates to a previous example (e.g., one of the examples 16 or 17) or to any other example, further comprising that the anomaly detection is based on identifying inconsistency, incompleteness, or conflict between the first audit data and the second audit data.

Another example (e.g., example 19) relates to a previous example (e.g., one of the examples 16 to 18) or to any other example, further comprising that the processing circuitry is further to trigger rerouting of the first and second audit data and a first and second attestation results to a fallback server if an anomaly is detected, the fallback system comprising a fallback trusted execution environment and being configured in a read-only configuration.

Another example (e.g., example 20) relates to a previous example (e.g., one of the examples 16 to 19) or to any other example, further comprising that the processing circuitry is further to verify a network topology comprising network devices and interconnections of the computing system based on signed topology data generated by the computing system.

Another example (e.g., example 21) relates to a previous example (e.g., example 20) or to any other example, further comprising that the anomaly detection includes detecting a presence of unauthorized devices or connections based on the verified network topology.

Another example (e.g., example 22) relates to a previous example (e.g., one of the examples 16 to 21) or to any other example, further comprising that the processing circuitry is further to store a signed integrity confirmation generated by an external auditor, the integrity confirmation indicating a point-in-time presence of aggregated audit data.

Another example (e.g., example 23) relates to a previous example (e.g., one of the examples 16 to 22) or to any other example, further comprising that the processing circuitry is further to receive first and second attestation results from respective attestation servers and correlate the attestation results with the first and second audit data to detect anomalies.

Another example (e.g., example 24) relates to a previous example (e.g., one of the examples 16 to 23) or to any other example, further comprising that the apparatus is implemented as a distributed ledger system or other public or consortium based verifiable data trust system comprising a plurality of computing nodes configured to collectively store and verify the first and second audit data.

Another example (e.g., example 25) relates to a previous example (e.g., one of the examples 16 to 24) or to any other example, further comprising that the signed integrity confirmation is stored in at least one of a write-once-read-many storage system or the distributed ledger system.

An example (e.g., example 26) relates to an apparatus comprising interface circuitry, machine-readable instructions, and processing circuitry to execute the machine-readable instructions to request first audit data from a first storage, the first audit data comprising signed system record data and log data generated by a first trusted execution environment operated by a remote entity at a computing system, the log data corresponding to activities of the computing system associated with data from the remote entity handled by the computing system, request second audit data from a second storage, the second audit data comprising signed system record data and log data generated by a second trusted execution environment operated by a host entity of the computing system, verify the first and second audit data based on their respective digital signatures and integrity constraints, request a first attestation result attesting the integrity of the first trusted execution environment and a second attestation result attesting the integrity of the second trusted execution environment, verify the first and second attestation results.

Another example (e.g., example 27) relates to a previous example (e.g., example 26) or to any other example, further comprising that the first storage and the second storage are write-once, read-many storage systems.

Another example (e.g., example 28) relates to a previous example (e.g., one of the examples 26 or 27) or to any other example, further comprising that verifying the first and second audit data comprises verifying the digital signatures of the system record data and log data using public keys associated with the respective trusted execution environments.

Another example (e.g., example 29) relates to a previous example (e.g., one of the examples 26 to 28) or to any other example, further comprising that the processing circuitry is further to verify the integrity of the first and second storages by checking for tampering or unauthorized modifications.

Another example (e.g., example 30) relates to a previous example (e.g., one of the examples 26 to 29) or to any other example, further comprising that the processing circuitry is further to verify the system record data to detect temporal gaps.

Another example (e.g., example 31) relates to a previous example (e.g., one of the examples 26 to 30) or to any other example, further comprising that the processing circuitry is further to generate a signed integrity confirmation indicating a point-in-time presence of the audit data and transmit the signed integrity confirmation to a detection system for storage.

Another example (e.g., example 32) relates to a previous example (e.g., example 31) or to any other example, further comprising that the signed integrity confirmation comprises a hash of the stored audit data.

Another example (e.g., example 33) relates to a previous example (e.g., one of the examples 26 to 32) or to any other example, further comprising that the signed integrity confirmation is stored in at least one of a write-once-read-many storage system or a distributed ledger system.

Another example (e.g., example 34) relates to a previous example (e.g., one of the examples 26 to 33) or to any other example, further comprising that the processing circuitry is further to verify network topology information based on signed topology data and identify inconsistencies or unauthorized devices.

Another example (e.g., example 35) relates to a previous example (e.g., one of the examples 26 to 34) or to any other example, further comprising that the processing circuitry is further to correlate the verified audit data with the attestation results to detect integrity violations or inconsistencies.

Another example (e.g., example 36) relates to a previous example (e.g., one of the examples 26 to 35) or to any other example, further comprising that the processing circuitry is further to generate a verification result based on the verified audit data and attestation results, the verification result indicating that access to data handled by the computing system was limited to entities authorized by the remote entity.

An example (e.g., example 37) relates to a system comprising the apparatus of any one examples 1 to 15, the apparatus of any one examples 16 to 26, and the apparatus of any one examples 27 to 36. 38. A method comprising receiving data from a remote entity for handling by a computing system, instantiating a first trusted execution environment, TEE, operated by a host entity of the computing system and a second TEE operated by the remote entity, generating log data corresponding to predefined activities of the computing system associated with the data from the remote entity, generating system record data of a system log of the computing system at predetermined times, generating first audit data by signing the system record data and the log data by the first TEE, and generate second audit data by signing the system record data and the log data by the second TEE, transmitting the first and the second audit data to a detection system for data aggregation and anomaly detection,

Another example (e.g., example 39) relates to a previous example (e.g., example 38) or to any other example, further comprising transmitting the first audit data to a first storage and the second audit data to a second storage.

Another example (e.g., example 40) relates to a previous example (e.g., example 37) or to any other example, further comprising that the first and the second storage are write-once, read-many storage systems.

Another example (e.g., example 41) relates to a previous example (e.g., one of the examples 38 to 40) or to any other example, further comprising that the detection system is configured to detect anomalies based on inconsistency, incompleteness, or conflict in the received first and second audit data.

Another example (e.g., example 42) relates to a previous example (e.g., one of the examples 38 to 41) or to any other example, further comprising requesting attestation of the first TEE from a first attestation server and attestation of the second TEE from a second attestation server.

Another example (e.g., example 43) relates to a previous example (e.g., one of the examples 41 to 42) or to any other example, further comprising receiving a first attestation result from the first attestation server indicating whether the first TEE meets integrity requirements, and receive a second attestation result from the second attestation server indicating whether the second TEE meets integrity requirements.

Another example (e.g., example 44) relates to a previous example (e.g., example 43) or to any other example, further comprising that the detection system is further configured to trigger automatic sequestration of a compromised attestation server based on anomaly detection.

Another example (e.g., example 45) relates to a previous example (e.g., one of the examples 42 to 44) or to any other example, further comprising transmitting the first and second attestation results to the detection system for data aggregation and anomaly detection.

Another example (e.g., example 46) relates to a previous example (e.g., one of the examples 38 to 45) or to any other example, further comprising transmitting the first and second audit data to a fallback system when the detection system detects an anomaly, the fallback system comprising a fallback trusted execution environment and being configured in a read-only configuration.

Another example (e.g., example 47) relates to a previous example (e.g., one of the examples 38 to 46) or to any other example, further comprising that the system record data comprises point-in-time state information extracted from a system log of an operating system of the computing system.

Another example (e.g., example 48) relates to a previous example (e.g., one of the examples 38 to 47) or to any other example, further comprising that the first trusted execution environment is configured to operate independently from the second trusted execution environment, and each environment is associated with a distinct root of trust.

Another example (e.g., example 49) relates to a previous example (e.g., one of the examples 38 to 48) or to any other example, further comprising that the log data comprises at least one of data access operations, file input/output operations, or network communication events associated with the data from the remote entity.

Another example (e.g., example 50) relates to a previous example (e.g., one of the examples 38 to 49) or to any other example, further comprising that generating the log data comprises monitoring at least one of data access operations, file input/output operations, or network communication events associated with the data from the remote entity.

Another example (e.g., example 51) relates to a previous example (e.g., one of the examples 38 to 50) or to any other example, further comprising performing a correlation on the monitored predefined activities of the computing system associated with the data from the remote entity. 52. The method of any one of examples 38 to 51, wherein the second TEE is configured to receive data input via a secure gateway comprising a hardware security module, the hardware security module being provisioned with access control policies defined by the remote entity and operating independently of the host operating system of the computing system.

An example (e.g., example 53) relates to a method comprising receiving first audit data from a first storage, the first audit data comprising signed system record data and log data generated by a first trusted execution environment operated by a remote entity at a computing system, the log data corresponding to activities of the computing system associated with data from the remote entity handled by the computing system, receiving second audit data from a second storage, the second audit data comprising signed system record data and log data generated by a second TEE operated by a host entity of the computing system, performing anomaly detection based on the first audit data and the second audit data.

Another example (e.g., example 54) relates to a previous example (e.g., example 53) or to any other example, further comprising that the first and second storage are write-once, read-many storage systems.

Another example (e.g., example 55) relates to a previous example (e.g., one of the examples 53 or 54) or to any other example, further comprising that the anomaly detection is based on identifying inconsistency, incompleteness, or conflict between the first audit data and the second audit data.

Another example (e.g., example 56) relates to a previous example (e.g., one of the examples 53 to 55) or to any other example, further comprising triggering rerouting of the first and second audit data and a first and second attestation results to a fallback server if an anomaly is detected, the fallback system comprising a fallback trusted execution environment and being configured in a read-only configuration.

Another example (e.g., example 57) relates to a previous example (e.g., one of the examples 53 to 56) or to any other example, further comprising verifying a network topology comprising network devices and interconnections of the computing system based on signed topology data generated by the computing system.

Another example (e.g., example 58) relates to a previous example (e.g., example 57) or to any other example, further comprising that the anomaly detection includes detecting a presence of unauthorized devices or connections based on the verified network topology.

Another example (e.g., example 59) relates to a previous example (e.g., one of the examples 53 to 58) or to any other example, further comprising storing a signed integrity confirmation generated by an external auditor, the integrity confirmation indicating a point-in-time presence of aggregated audit data.

Another example (e.g., example 60) relates to a previous example (e.g., one of the examples 53 to 59) or to any other example, further comprising receiving first and second attestation results from respective attestation servers and correlate the attestation results with the first and second audit data to detect anomalies.

Another example (e.g., example 61) relates to a previous example (e.g., one of the examples 53 to 60) or to any other example, further comprising that the signed integrity confirmation is stored in a write-once-read-many storage system

Another example (e.g., example 62) relates to a previous example (e.g., one of the examples 53 to 60) or to any other example, further comprising that the signed integrity confirmation is stored in the distributed ledger system.

An example (e.g., example 63) relates to a method comprising requesting first audit data from a first storage, the first audit data comprising signed system record data and log data generated by a first trusted execution environment operated by a remote entity at a computing system, the log data corresponding to activities of the computing system associated with data from the remote entity handled by the computing system, requesting second audit data from a second storage, the second audit data comprising signed system record data and log data generated by a second trusted execution environment operated by a host entity of the computing system, verifying the first and second audit data based on their respective digital signatures and integrity constraints, requesting a first attestation result attesting the integrity of the first trusted execution environment and a second attestation result attesting the integrity of the second trusted execution environment, verifying the first and second attestation results.

Another example (e.g., example 64) relates to a previous example (e.g., example 63) or to any other example, further comprising that the first storage and the second storage are write-once, read-many storage systems.

Another example (e.g., example 65) relates to a previous example (e.g., one of the examples 63 or 64) or to any other example, further comprising that verifying the first and second audit data comprises verifying the digital signatures of the system record data and log data using public keys associated with the respective trusted execution environments.

Another example (e.g., example 66) relates to a previous example (e.g., one of the examples 63 to 65) or to any other example, further comprising verifying the integrity of the first and second storages by checking for tampering or unauthorized modifications.

Another example (e.g., example 67) relates to a previous example (e.g., one of the examples 63 to 66) or to any other example, further comprising verifying the system record data to detect temporal gaps.

Another example (e.g., example 68) relates to a previous example (e.g., one of the examples 63 to 67) or to any other example, further comprising generating a signed integrity confirmation indicating a point-in-time presence of the audit data and transmit the signed integrity confirmation to a detection system for storage.

Another example (e.g., example 69) relates to a previous example (e.g., example 68) or to any other example, further comprising that the signed integrity confirmation comprises a hash of the stored audit data.

Another example (e.g., example 70) relates to a previous example (e.g., one of the examples 63 to 69) or to any other example, further comprising that the signed integrity confirmation is stored in at least one of a write-once-read-many storage system or a distributed ledger system.

Another example (e.g., example 71) relates to a previous example (e.g., one of the examples 63 to 70) or to any other example, further comprising verifying network topology information based on signed topology data and identify inconsistencies or unauthorized devices.

Another example (e.g., example 72) relates to a previous example (e.g., one of the examples 63 to 71) or to any other example, further comprising correlating the verified audit data with the attestation results to detect integrity violations or inconsistencies.

Another example (e.g., example 73) relates to a previous example (e.g., one of the examples 26 to 35) or to any other example, further comprising generating a verification result based on the verified audit data and attestation results, the verification result indicating that access to data handled by the computing system was limited to entities authorized by the remote entity.

An example (e.g., example 74) relates to an apparatus comprising a processor circuitry configured to receive data from a remote entity for handling by a computing system, instantiate a first trusted execution environment, TEE, operated by a host entity of the computing system and a second TEE operated by the remote entity, generate log data corresponding to predefined activities of the computing system associated with the data from the remote entity, generate system record data of a system log of the computing system at predetermined times, generate first audit data by signing the system record data and the log data by the first TEE, and generate second audit data by signing the system record data and the log data by the second TEE, transmit the first and the second audit data to a detection system for data aggregation and anomaly detection.

An example (e.g., example 75) relates to a device comprising means for processing for receiving data from a remote entity for handling by a computing system, instantiating a first trusted execution environment, TEE, operated by a host entity of the computing system and a second TEE operated by the remote entity, generating log data corresponding to predefined activities of the computing system associated with the data from the remote entity, generating system record data of a system log of the computing system at predetermined times, generating first audit data by signing the system record data and the log data by the first TEE, and generate second audit data by signing the system record data and the log data by the second TEE, transmitting the first and the second audit data to a detection system for data aggregation and anomaly detection.

Another example (e.g., example 76) relates to a computer program having a program code for performing the method of any one of examples 38 to 52 when the computer program is executed on a computer, a processor, or a programmable hardware component.

Another example (e.g., example 77) relates to a computer-readable medium including program code, when executed, to cause a machine to perform the method of any one of examples 38 to 52.

Another example (e.g., example 78) relates machine-readable storage including machine readable instructions, when executed, to implement a method or realize an apparatus as claimed in any pending examples.

An example (e.g., example 79) relates to an apparatus comprising a processor circuitry configured to receive first audit data from a first storage, the first audit data comprising signed system record data and log data generated by a first trusted execution environment operated by a remote entity at a computing system, the log data corresponding to activities of the computing system associated with data from the remote entity handled by the computing system, receive second audit data from a second storage, the second audit data comprising signed system record data and log data generated by a second TEE operated by a host entity of the computing system, perform anomaly detection based on the first audit data and the second audit data.

An example (e.g., example 80) relates to a device comprising means for processing for receiving first audit data from a first storage, the first audit data comprising signed system record data and log data generated by a first trusted execution environment operated by a remote entity at a computing system, the log data corresponding to activities of the computing system associated with data from the remote entity handled by the computing system, receiving second audit data from a second storage, the second audit data comprising signed system record data and log data generated by a second TEE operated by a host entity of the computing system, performing anomaly detection based on the first audit data and the second audit data.

Another example (e.g., example 81) relates to a computer program having a program code for performing the method of any one of examples 53 to 62 when the computer program is executed on a computer, a processor, or a programmable hardware component.

Another example (e.g., example 82) relates to a computer-readable medium including program code, when executed, to cause a machine to perform the method of any one of examples 53 to 62.

Another example (e.g., example 83) relates machine-readable storage including machine readable instructions, when executed, to implement a method or realize an apparatus as claimed in any pending examples.

An example (e.g., example 84) relates to an apparatus comprising a processor circuitry configured to request first audit data from a first storage, the first audit data comprising signed system record data and log data generated by a first trusted execution environment operated by a remote entity at a computing system, the log data corresponding to activities of the computing system associated with data from the remote entity handled by the computing system, request second audit data from a second storage, the second audit data comprising signed system record data and log data generated by a second trusted execution environment operated by a host entity of the computing system, verify the first and second audit data based on their respective digital signatures and integrity constraints, request a first attestation result attesting the integrity of the first trusted execution environment and a second attestation result attesting the integrity of the second trusted execution environment, verify the first and second attestation results.

An example (e.g., example 85) relates to a device comprising means for processing for requesting first audit data from a first storage, the first audit data comprising signed system record data and log data generated by a first trusted execution environment operated by a remote entity at a computing system, the log data corresponding to activities of the computing system associated with data from the remote entity handled by the computing system, requesting second audit data from a second storage, the second audit data comprising signed system record data and log data generated by a second trusted execution environment operated by a host entity of the computing system, verifying the first and second audit data based on their respective digital signatures and integrity constraints, requesting a first attestation result attesting the integrity of the first trusted execution environment and a second attestation result attesting the integrity of the second trusted execution environment, verifying the first and second attestation results.

Another example (e.g., example 86) relates to a computer program having a program code for performing the method of any one of examples 63 to 73 when the computer program is executed on a computer, a processor, or a programmable hardware component.

Another example (e.g., example 87) relates to a computer-readable medium including program code, when executed, to cause a machine to perform the method of any one of examples 63 to 73.

Another example (e.g., example 88) relates machine-readable storage including machine readable instructions, when executed, to implement a method or realize an apparatus as claimed in any pending examples.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processing circuitry to execute the machine-readable instructions to:
receive data from a remote entity for handling by a computing system;
instantiate a first trusted execution environment, TEE, operated by a host entity of the computing system and a second TEE operated by the remote entity;
generate log data corresponding to predefined activities of the computing system associated with the data from the remote entity;
generate system record data of a system log of the computing system at predetermined times;
generate first audit data by signing the system record data and the log data by the first TEE, and generate second audit data by signing the system record data and the log data by the second TEE;
transmit the first and the second audit data to a detection system for data aggregation and anomaly detection.

2. The apparatus of claim 1, wherein the processing circuitry is further to execute the machine-readable instructions to transmit the first audit data to a first storage and the second audit data to a second storage.

3. The apparatus of claim 1, wherein the processing circuitry is further to request attestation of the first TEE from a first attestation server and attestation of the second TEE from a second attestation server.

4. The apparatus of claim 3, wherein the processing circuitry is further to receive a first attestation result from the first attestation server indicating whether the first TEE meets integrity requirements, and receive a second attestation result from the second attestation server indicating whether the second TEE meets integrity requirements.

5. The apparatus of claim 1, wherein the detection system is further configured to trigger automatic sequestration of a compromised attestation server based on anomaly detection.

6. The apparatus of claim 1, wherein the processing circuitry is further to transmit the first and second audit data to a fallback system when the detection system detects an anomaly, the fallback system comprising a fallback trusted execution environment and being configured in a read-only configuration.

7. The apparatus of claim 1, wherein the system record data comprises point-in-time state information extracted from a system log of an operating system of the computing system.

8. The apparatus of claim 1, wherein the first trusted execution environment is configured to operate independently from the second trusted execution environment, and each environment is associated with a distinct root of trust.

9. The apparatus of claim 1, wherein the processing circuitry is further to perform a correlation on the monitored predefined activities of the computing system associated with the data from the remote entity.

10. An apparatus comprising interface circuitry, machine-readable instructions, and processing circuitry to execute the machine-readable instructions to:
receive first audit data from a first storage, the first audit data comprising signed system record data and log data generated by a first trusted execution environment operated by a remote entity at a computing system, the log data corresponding to activities of the computing system associated with data from the remote entity handled by the computing system;
receive second audit data from a second storage, the second audit data comprising signed system record data and log data generated by a second TEE operated by a host entity of the computing system;
perform anomaly detection based on the first audit data and the second audit data.

11. The apparatus of claim 10, wherein the anomaly detection is based on identifying inconsistency, incompleteness, or conflict between the first audit data and the second audit data.

12. The apparatus of claim 10, wherein the processing circuitry is further to trigger rerouting of the first and second audit data and a first and second attestation results to a fallback server, if an anomaly is detected, the fallback system comprising a fallback trusted execution environment and being configured in a read-only configuration.

13. The apparatus of claim 10, wherein the processing circuitry is further to verify a network topology comprising network devices and interconnections of the computing system based on signed topology data generated by the computing system.

14. The apparatus of claim 13, wherein the anomaly detection includes detecting a presence of unauthorized devices or connections based on the verified network topology.

15. The apparatus of claim 10, wherein the apparatus is implemented as a distributed ledger system or other public or consortium based verifiable data trust system comprising a plurality of computing nodes configured to collectively store and verify the first and second audit data.

16. The apparatus of claim 10, wherein the signed integrity confirmation is stored in at least one of a write-once-read-many storage system or the distributed ledger system.

17. An apparatus comprising interface circuitry, machine-readable instructions, and processing circuitry to execute the machine-readable instructions to:
request first audit data from a first storage, the first audit data comprising signed system record data and log data generated by a first trusted execution environment operated by a remote entity at a computing system, the log data corresponding to activities of the computing system associated with data from the remote entity handled by the computing system;
request second audit data from a second storage, the second audit data comprising signed system record data and log data generated by a second trusted execution environment operated by a host entity of the computing system;
verify the first and second audit data based on their respective digital signatures and integrity constraints;
request a first attestation result attesting the integrity of the first trusted execution environment and a second attestation result attesting the integrity of the second trusted execution environment;
verify the first and second attestation results.

18. The apparatus of claim 17, wherein the processing circuitry is further to verify the system record data to detect temporal gaps.

19. The apparatus of claim 17, wherein the processing circuitry is further to generate a signed integrity confirmation indicating a point-in-time presence of the audit data and transmit the signed integrity confirmation to a detection system for storage.

20. The apparatus of claim 17, wherein the processing circuitry is further to generate a verification result based on the verified audit data and attestation results, the verification result indicating that access to data handled by the computing system was limited to entities authorized by the remote entity.
